(19) United States
(12) Patent Application Publication
(10) Pub. No.: US 2025/0363103 A1
(43) Pub. Date: Nov. 27, 2025

(54) DATA PROCESSING METHOD, COMPUTER DEVICE, AND STORAGE MEDIUM

(71) Applicant: TENCENT TECHNOLOGY (SHENZHEN) COMPANY LIMITED, Shenzhen (CN)

(72) Inventor: Yahui CHENG, Shenzhen (CN)

(21) Appl. No.: 19/292,293

(22) Filed: Aug. 6, 2025

Related U.S. Application Data
(63) Continuation of application No. PCT/CN2023/128556, filed on Oct. 31, 2023.

(30) Foreign Application Priority Data
Jun. 19, 2023 (CN) 202310731911.0

(51) Int. Cl. G06F 16/245

(52) U.S. Cl. CPC G06F 16/245

(57) ABSTRACT

A data processing method includes: performing, when obtaining an initial model, structure search on the initial model to obtain a model structure diagram of the initial model; quantizing, based on a type of a target structure in the model structure diagram of the initial model, the target structure of the initial model by applying a fake operator for quantization, the fake operator comprising a quantization operator and a dequantization operator; and obtaining, based on the quantized initial model, a service model for service processing.

### CROSS-REFERENCES TO RELATED APPLICATIONS

This application is a continuation application of PCT Patent Application No. PCT/CN2023/128556, filed on Oct. 31, 2023, which claims priority to Chinese Patent Application No. 202310731911.0, filed on Jun. 19, 2023, all of which is incorporated herein by reference in their entirety.

### FIELD OF THE TECHNOLOGY

The present disclosure relates to the field of computer technologies, and in particular, to a data processing method and apparatus, a computer device, and a storage medium.

### BACKGROUND OF THE DISCLOSURE

With continuous development of artificial intelligence (AI) technologies, the structure of an artificial intelligence models (i.e., AI models) has been designed increasingly complex, and the weight parameters of the AI models have become larger and larger. As a result, the hardware requirements for performing forward inference have also become higher. However, on terminal devices that have limited computing resources but require high real-time performance, deploying AI models effectively requires certain “compression” techniques, and quantization is one such model compression method.

In a quantization method, the AI models usually need to be manually modified to insert corresponding fake operators (i.e., quantization and dequantization operators). This leads to high code invasiveness and making code reuse difficult. In other words, different quantization schemes need to be designed for different model structures, which not only affects the quantization speed, but also makes model quantization in a lack of generality.

### SUMMARY

One embodiment of the present disclosure provides data processing method. The data processing method includes performing, when obtaining an initial model, structure search on the initial model to obtain a model structure diagram of the initial model; quantizing, based on a type of a target structure in the model structure diagram of the initial model, the target structure of the initial model by applying a fake operator for quantization, the fake operator including a quantization operator and a dequantization operator; and obtaining, based on the quantized initial model, a service model for service processing.

Another embodiment of the present disclosure provides a computer device. The computer device includes one or more processors, a memory, and a network interface, the one or processor being connected to the memory and the network interface, the network interface being configured to provide a data communication function, and the memory being configured to store a computer program that, when being executed, causes the one or more processors to perform: performing, when obtaining an initial model, structure search on the initial model to obtain a model structure diagram of the initial model; quantizing, based on a type of a target structure in the model structure diagram of the initial model, the target structure of the initial model by applying a fake operator for quantization, the fake operator including a quantization operator and a dequantization operator; and obtaining, based on the quantized initial model, a service model for service processing.

Another embodiment of the present disclosure provides a non-transitory computer-readable storage medium containing a computer program that, when being executed, causes at least one computer program to perform: performing, when obtaining an initial model, structure search on the initial model to obtain a model structure diagram of the initial model; quantizing, based on a type of a target structure in the model structure diagram of the initial model, the target structure of the initial model by applying a fake operator for quantization, the fake operator including a quantization operator and a dequantization operator; and obtaining, based on the quantized initial model, a service model for service processing.

### BRIEF DESCRIPTION OF THE DRAWINGS

To describe the technical solutions in the embodiments of the present disclosure or in the related art more clearly, the following briefly describes the accompanying drawings required to be used for describing the embodiments or the related art. Apparently, the accompanying drawings in the following descriptions show merely some embodiments of the present disclosure, and a person of ordinary skill in the art may still derive other drawings from the accompanying drawings without creative efforts.

FIG. 1 is a schematic diagram of a structure of a network architecture according to an embodiment of the present disclosure.

FIG. 2 is a schematic diagram of a structure of a plurality of to-be-quantized structures according to an embodiment of the present disclosure.

FIG. 3 is a schematic flowchart of a data processing method according to an embodiment of the present disclosure.

FIG. 4 is a schematic diagram of quantizing a target structure according to an embodiment of the present disclosure.

FIG. 5 is another schematic diagram of quantizing a target structure according to an embodiment of the present disclosure.

FIG. 6 is another schematic diagram of quantizing a target structure according to an embodiment of the present disclosure.

FIG. 7 is another schematic diagram of quantizing a target structure according to an embodiment of the present disclosure.

FIG. 8 is another schematic diagram of quantizing a target structure according to an embodiment of the present disclosure.

FIG. 9 is a schematic diagram of processing a to-be-optimized structure in a second model according to an embodiment of the present disclosure.

FIG. 10 is another schematic diagram of processing a to-be-optimized structure in a second model according to an embodiment of the present disclosure.

FIG. 11 is another schematic diagram of processing a to-be-optimized structure in a second model according to an embodiment of the present disclosure.

FIG. 12 is another schematic diagram of processing a to-be-optimized structure in a second model according to an embodiment of the present disclosure.

FIG. 13 is another schematic diagram of processing a to-be-optimized structure in a second model according to an embodiment of the present disclosure.

FIG. 14 is a schematic flowchart of a data processing method according to an embodiment of the present disclosure.

FIG. 15 is a schematic diagram of a scenario of performing model optimization on a service model according to an embodiment of the present disclosure.

FIG. 16 is a schematic diagram of a structure of a data processing apparatus according to an embodiment of the present disclosure.

FIG. 17 is a schematic diagram of a computer device according to an embodiment of the present disclosure.

### DESCRIPTION OF EMBODIMENTS

The technical solutions in embodiments of the present disclosure are clearly and completely described in the following with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

The embodiments of the present disclosure provide a general quantization method for an artificial intelligence model of a complex structure. The quantization method relates to the field of artificial intelligence. Artificial intelligence (AI) involves a theory, a method, a technology, and an application system that use a digital computer or a machine controlled by a digital computer to simulate, extend, and expand human intelligence, perceive an environment, obtain knowledge, and use knowledge to obtain an optimal result. In other words, artificial intelligence is a comprehensive technology in computer science and attempts to understand the essence of intelligence and produce a new intelligent machine that can react in a manner similar to human intelligence. Artificial intelligence is to study the design principles and implementation methods of various intelligent machines, to enable the machines to have the functions of perception, reasoning, and decision-making.

The artificial intelligence technology is a comprehensive discipline, and relates to a wide range of fields including both hardware-level technologies and software-level technologies. Basic artificial intelligence technologies generally include technologies such as a sensor, a dedicated artificial intelligence chip, cloud computing, distributed storage, a big data processing technology, an operating/interaction system, and electromechanical integration. Artificial intelligence software technologies mainly include some major directions such as a computer vision technology, a speech processing technology, a natural language processing technology, and machine learning/deep learning, automated driving, and smart transportation.

Machine learning (ML) is a multi-field interdiscipline, relates to a plurality of disciplines such as the probability theory, statistics, the approximation theory, convex analysis, and the algorithm complexity theory, and specializes in studying how a computer simulates or implements a human learning behavior to obtain new knowledge or skills, and reorganize an existing knowledge structure, so as to keep improving its performance. Machine learning is the core of artificial intelligence, is a basic way to make the computer intelligent, and is applied to various fields of artificial intelligence. Machine learning and deep learning generally include technologies such as an artificial neural network, a belief network, reinforcement learning, transfer learning, inductive learning, and learning from demonstrations.

A deep learning algorithm includes calculation units. In the embodiments of the present disclosure, these calculation units may be referred to as operators (OPs). In a network model, an operator corresponds to calculation logic at a network layer. For example, an operator (that is, a convolution operator) corresponding to a convolution layer may be configured for representing performing convolution calculation once. A weight summation process at a fully-connected (FC) layer is also an operator. An operator (that is, an activation operator) corresponding to an activation layer is an operator (for example, tanh or ReLU) used as an activation function in the network model.

A computer vision (CV) technology is a science that studies how to use a machine to “see”, and furthermore, that uses a camera and a computer to replace human eyes to perform machine vision such as recognition and measurement on a target, and further perform graphic processing, so that the computer processes the target into an image more suitable for human eyes to observe, or an image transmitted to an instrument for detection. As a scientific discipline, computer vision studies related theories and technologies and attempts to establish an artificial intelligence system that can obtain information from images or multidimensional data. The computer vision technology generally includes technologies such as image processing, image recognition, image semantic understanding, image retrieval, OCR, video processing, video semantic understanding, video content/behavior recognition, three-dimensional object reconstruction, a 3D technology, virtual reality, augmented reality, synchronous positioning and map construction, autonomous driving, and smart transportation, and further include biological feature recognition technologies such as common face recognition and fingerprint recognition.

Natural language processing (NLP) is an important direction in the field of computer science and the field of artificial intelligence. It studies various theories and methods that can realize efficient communication between humans and computers by using a natural language. Natural language processing is a science that integrates linguistics, computer science, and mathematics. Therefore, the study in this field will involve the natural language, that is, the language used by people in daily life, so it is closely related to the study of linguistics. The natural language processing technology usually includes technologies such as text processing, semantic understanding, machine translation, robot question answering, and knowledge mapping.

Key technologies of a speech technology include an automatic speech recognition technology, a speech synthesis technology, and a voiceprint recognition technology. Making a computer listen, see, speak, and feel is a development direction of human-computer interaction in the future, and speech becomes one of the most promising human-computer interaction manners in the future.

With rapid application of the deep learning technology to a plurality of fields, specifically including computer vision, natural language processing, a language technology, and the like, a large quantity of deep learning-based network models emerge. To resolve the problem that these models are inconvenient to be deployed in some low-cost terminal devices due to increasingly complex model structures, in the embodiments of the present disclosure, an artificial intelligence model may be quantized by using a general quantization method, so that a quantized model has the following advantages: lower storage overheads, a lower bandwidth requirement, a higher calculation speed, lower energy consumption, a smaller occupied area, an acceptable precision loss, support in low precision (for example, int8), and the like.

Embodiments of the present disclosure provide a data processing method and apparatus, a computer device, and a storage medium, which may be applied to an artificial intelligence scenario. The method includes: performing, when obtaining an initial model, structure search on the initial model to obtain a model structure diagram of the initial model; quantizing, based on a type of a target structure in the model structure diagram, the target structure by using a fake operator for quantization, the fake operator including a quantization operator and a dequantization operator; and obtaining, based on the quantized initial model, a service model for service processing. According to the embodiments of the present disclosure, a model quantization speed can be improved, and generality of model quantization can be achieved.

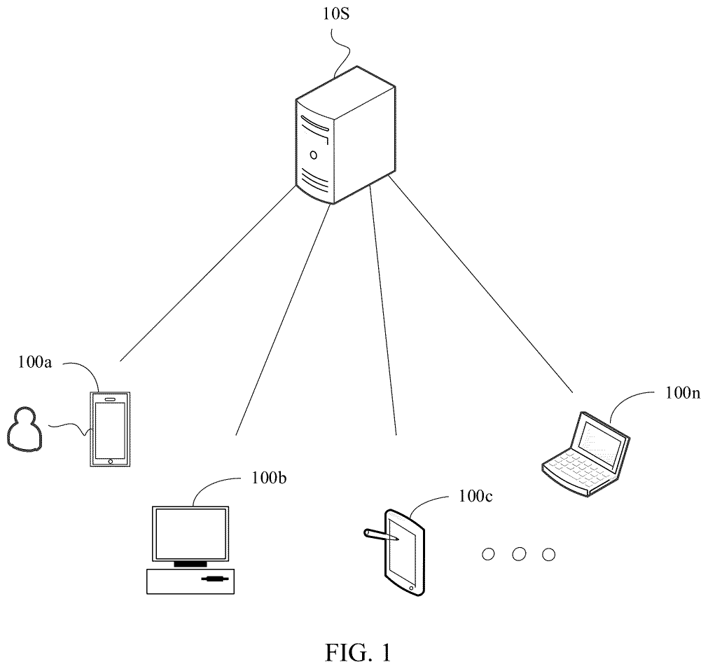

FIG. 1 is a schematic diagram of a structure of a network architecture according to an embodiment of the present disclosure. As shown in FIG. 1, the network architecture may include a server 10S and a terminal device cluster. The terminal device cluster may include one or more terminal devices. A quantity of terminal devices is not limited herein. As shown in FIG. 1, the terminal device cluster may include a terminal device 100a, a terminal device 100b, a terminal device 100c, . . . , and a terminal device 100n. As shown in FIG. 1, the terminal device 100a, the terminal device 100b, the terminal device 100c, . . . , and the terminal device 100n may establish a network connection to the server 10S, so that each terminal device can exchange data with the server 10S by using the network connection. A connection manner of the network connection is not limited. Wired communication may be used for direct or indirect connection, wireless communication may be used for direct or indirect connection, or another manner may be used. This is not limited herein in the present disclosure.

Each terminal device in the terminal device cluster may include a smartphone, a tablet computer, a notebook computer, a desktop computer, a smart speaker, a smartwatch, an in-vehicle terminal, a smart television, or another intelligent terminal with a data processing function. A service application (that is, an application client) may be installed on each terminal device in the terminal device cluster shown in FIG. 1. When run on each terminal device, the application client may exchange data with the server 10S shown in FIG. 1. The application client may include a social client, a multimedia client (for example, a video client), an entertainment client (for example, a game client), an information flow client, an education client, a live-streaming client, or another application client. The application client may be an independent client, or may be an embedded sub-client integrated in a specific client (for example, the social client, the education client, and the multimedia client). This is not limited herein.

As shown in FIG. 1, the server 10S In one embodiment may be a server corresponding to the application client. The server 10S may be an independent physical server, may be a server cluster or a distributed system including a plurality of physical servers, or may be a cloud server that provides a cloud computing service. A quantity of servers is not limited In one embodiment.

For ease of understanding, In one embodiment, one terminal device may be selected from the plurality of terminal devices shown in FIG. 1 as a target service terminal device used by a service object. For example, In one embodiment, the terminal device 100a shown in FIG. 1 may be used as the service terminal device, and the service application (that is, the application client) may be integrated in the service terminal device. In this case, the service terminal device may implement data exchange with the server 10S via a service data platform corresponding to the application client. In a model quantization scenario, to effectively control calculation precision of each module in an artificial intelligence model, when a specific initial model of a complex structure is optimized, the service object (for example, a user) herein may specify some network layers in the initial model not to participate in quantization. In one embodiment, a network layer that is specified by the service object not to participate in quantization may be referred to as a specified network layer (that is, a network layer belonging to a blacklist).

In one embodiment, a computer device with a model quantification function may be a server, or may be any terminal device in the terminal device cluster shown in FIG. 1, for example, the terminal device 100b. A specific form of the computer device is not limited herein. For ease of understanding, an example in which the computer device In one embodiment is the server (for example, the server 10S shown in FIG. 1) may be used to describe a specific implementation in which the computer device automatically quantizes the initial model by using a general quantization tool.

The general quantization tool In one embodiment designs various to-be-quantized structures suitable for low-precision (for example, int8) acceleration by using rich reasoning experience, that is, sets different quantization rules for different types of to-be-quantized structures, to obtain an initial rule set, so that subsequently, the obtained initial model may be automatically quantized directly based on a quantization rule set determined by the initial rule set.

If the service object does not configure the specified network layer that does not participate in quantization, the quantization rule set herein is the initial rule set obtained by the general quantization tool. If the service object configures the specified network layer that does not participate in quantization, the quantization rule set herein is a rule set obtained by filtering the initial rule set based on the specified network layer configured by the service object. This means that In one embodiment, the specified network layer configured by the service object has a quantization priority higher than that of the general initial rule set, and has a highest quantization priority.

The quantization rule set herein may include N quantization rules, N being a positive integer, and one quantization rule corresponding to one to-be-quantized structure. When obtaining a to-be-optimized initial model, the computer device needs to perform structure search on the initial model to obtain a model structure diagram of the initial model, and may further query the model structure diagram for whether a target structure exists. The target structure herein belongs to the N to-be-quantized structures corresponding to the quantization rule set. If the target structure exists in the model structure diagram, the computer device may automatically determine, from the N quantization rules, a target quantization rule matching the target structure, further quantize the target structure based on the target quantization rule and a fake operator, and after ending quantization, determine, based on a quantized initial model, a service model for service processing.

The fake operator (for example, fake op) herein is mainly configured for first performing quantization and then performing dequantization on a parameter and an input that are input into the fake operator, that is, is equivalent to a QDQ operator, and the fake operator structurally includes a quantization operator (quant op) and a dequantization operator (dequant op). The fake operator may be configured for storing quantization information of a current layer, and may specifically include a scaling factor (scale) and an offset (zero-point). In one embodiment, precision of an operator for each layer may be further determined based on locations of a quantization operator and a dequantization operator in the fake operator.

The quantization operator is mainly configured for converting a feature of first precision into a feature of second precision. The dequantization operator is mainly configured for converting the feature of the second precision back into the feature of the first precision. The first precision herein is higher than the second precision. For example, quantization may convert a floating-point real number (for example, FP32) into an integer number (for example, INT8), and dequantization may convert the integer number (for example, INT8) back to the floating-point real number (for example, FP32).

The initial model herein may include models in various artificial intelligence scenarios, for example, a detection model configured for reviewing content, a detection model (for example, a face detection model) configured for recognizing a key part, and an image recognition model. An application scenario of the initial model is not limited herein. In other words, for any initial model of a complex structure, the computer device may automatically quantize, according to a preset quantization rule set, an accelerable to-be-quantized structure existing in the initial model, to determine, based on a quantized initial model, a service model for service processing. In this quantization method, there is no need to design different quantization solutions for different models, but the accelerable to-be-quantized structure existing in the initial model can be automatically quantized. This can not only effectively reduce labor costs, but also improve a model quantization speed. In addition, because there is no need to manually insert a fake operator in this quantization method In one embodiment, code invasiveness is reduced, achieving generality of model quantization.

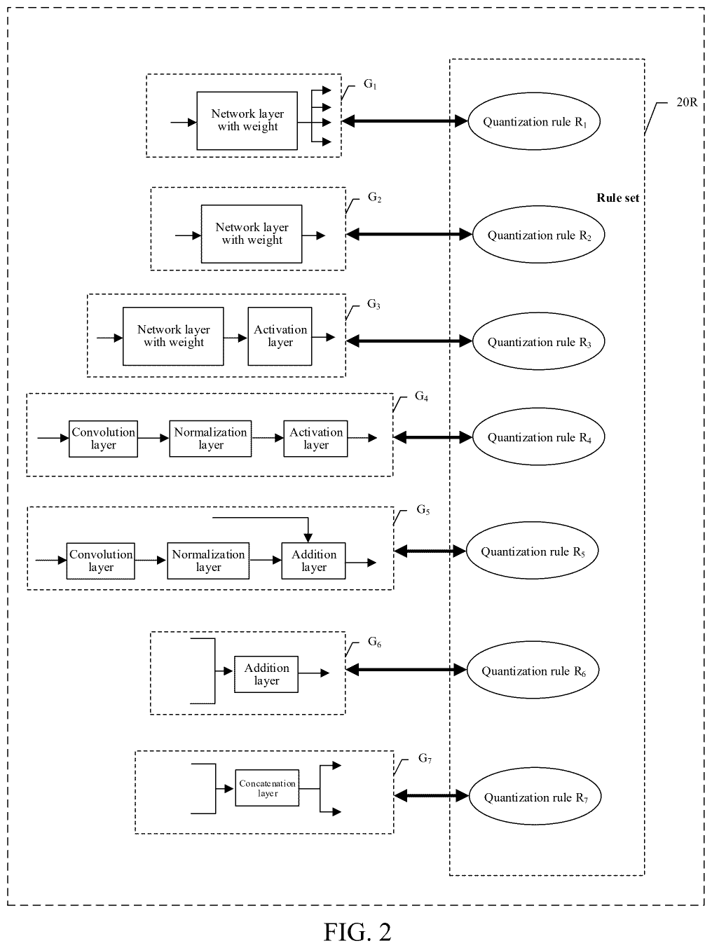

FIG. 2 is a schematic diagram of a structure of a plurality of to-be-quantized structures according to an embodiment of the present disclosure. A computer device In one embodiment may be a computer device with a model quantification function. The computer device may be any terminal device in the terminal device cluster shown in FIG. 1, for example, the terminal device 100b. The computer device may alternatively be the server 10S shown in FIG. 1. The computer device is not limited herein.

In one embodiment, various to-be-quantized structures (patterns) suitable for low-precision acceleration may be designed based on rich reasoning experience in a specific deep learning reasoning framework, and further, different quantization rules may be designed based on different to-be-quantized structures. The to-be-quantized structure herein is of a smallest-granularity type for search in the present disclosure. The to-be-quantized structure may be a module including a plurality of network layers, or may be a module including a single network layer.

As shown in FIG. 2, a rule set 20R is an initial rule set obtained by the computer device In one embodiment. The rule set 20R may include M general quantization rules, M being a positive integer, and one quantization rule corresponding to one to-be-quantized structure. For ease of description, there may be, for example, seven quantization rules in the rule set 20R, specifically including a quantization rule R1, a quantization rule R2, a quantization rule R3, a quantization rule R4, a quantization rule R5, a quantization rule R6, and a quantization rule R7.

The quantization rule R1, the quantization rule R2, and the quantization rule R3 are quantization rules designed for a to-be-quantized structure of a network layer with a weight. The network layer with a weight herein is a network layer with a weighted operation, for example, a convolution layer (conv), a transposed convolution layer (for example, transpose conv), and general matrix multiplication (for example, gemm). When the network layer with a weight is the convolution layer, the quantization rule R4 and the quantization rule R5 may be further designed.

For example, as shown in FIG. 2, if a network layer with a weight in a structure G1 (for example, an attention structure (attention structure)) has a plurality of output locations, a quantization rule R1 corresponding to the structure G1 may indicate to add fake operators separately to an input location of the network layer with a weight and the plurality of output locations of the network layer with a weight, and quantize a weight of the network layer with a weight by using the fake operators. For example, when the structure G1 is the attention structure (attention structure), the structure may include a convolution operator (conv operator), a matrix reshape operator (reshape operator), a permutation operator (permute operator), and a bmm matrix multiplication operator.

When a structure G2 includes a network layer with a weight, the quantization rule R2 may indicate to add, when high-precision calculation is reserved, a fake operator to an input location of the network layer with a weight, and quantize a weight of the network layer with a weight by using the fake operator, or add, when high-precision calculation is reserved, fake operators separately to an input location of the network layer with a weight and an output location of the network layer with a weight, and quantize a weight of the network layer with a weight by using the fake operators.

As can be known according to reasoning experience, the network layer with a weight is usually followed by an activation layer, and adding the fake operator to the output location of the network layer may cause an unacceptable precision loss when high-precision calculation is reserved. Based on this, if the network layer with a weight included in the structure G2 has one output location and no activation layer is connected to the output location of the network layer with a weight, according to the quantization rule R2 corresponding to the structure G2, fake operators may be added separately to the input location of the network layer with a weight and the output location of the network layer with a weight, and the weight of the network layer with a weight may be quantized by using the fake operators. If a network layer with a weight included in a structure G3 has one output location and the activation layer is connected to the output location of the network layer with a weight, according to the quantization rule R3 corresponding to the structure G3, a fake operator may be added to an input location of the network layer with a weight, and a weight of the network layer with a weight may be quantized by using the fake operator, that is, no fake operator may be added to the output location of the network layer with a weight.

In addition, as can be known according to reasoning experience, operators of original network layers can be automatically fused in a structure (for example, a structure G4 shown in FIG. 2) including a convolution layer, a normalization layer (for example, BN), and an activation layer (for example, ReLU) at a model reasoning stage. Therefore, the quantization rule R4 corresponding to the structure G4 may indicate to add a fake operator to an input location of the convolution layer, and quantize a weight of the convolution layer by using the fake operator.

As can be known according to reasoning experience, precision of an input of a non-weighted operation at an addition layer determines output precision of an operator after structure fusion. In other words, if the input of the non-weighted operation at the addition layer does not participate in quantization, a quantization operator after an output of the addition layer is not fused. This causes a precision conversion process of a fused operator, affecting a speed. Based on this, in a case that a structure G5 includes an addition layer, a first input branch (including a convolution layer and a normalization layer that are sequentially connected) of the addition layer, and a second input branch (that is, a type is a non-weighted operation input type) of the addition layer, and the addition layer includes the first input branch (a branch with a weighted operation) and the second input branch, the quantization rule R5 corresponding to the structure G5 may indicate to add, when a high speed needs to be maintained, fake operators separately to an input location of the convolution layer, an input location of the second input branch of the addition layer, and an output location of the addition layer, and quantize a weight of the convolution layer by using the fake operators, or add, when there is no requirement on a speed, fake operators separately to an input location of the convolution layer and an output location of the addition layer, and quantize a weight of the convolution layer by using the fake operators, that is, add no fake operator to an input location of the second input branch of the addition layer. For example, the structure G5 shown in FIG. 2 may be a skip connection structure associated with the addition layer (for example, Add), for example, a skip connection structure in a residual network (ResNet) or a lightweight network (Efficient Net).

As can be known according to reasoning experience, when a low-precision input on which no weighted operation is performed exists in two input branches of an addition layer, an output branch of the addition layer needs quantization. Based on this, if a structure G6 shown in FIG. 2 may include an addition layer and types of two input branches of the addition layer are both a non-weighted operation input type, the quantization rule R6 corresponding to the structure G6 may indicate to add fake operators separately to two input locations of the addition layer and an output location of the addition layer.

As can be known according to reasoning experience, in a particular case, a quantization operator (that is, a Q operator) in a fake operator may be equivalently propagated forward, and a dequantization operator (that is, a DQ operator) in the fake operator may be equivalently propagated backward. Therefore, if a fake operator is added to each output location of a concatenation layer (for example, Concat), calculation after the concatenation layer is of second precision. However, to quantize a concatenation operator corresponding to the concatenation layer, quantization operators in fake operators added to two output branches need to be the same. Based on this, if a structure G7 shown in FIG. 2 includes a concatenation layer and a quantity (for example, N) of input branches of the concatenation layer is the same as a quantity of output branches of the concatenation layer, the quantization rule R7 corresponding to the structure G7 may indicate to add fake operators with a same quantization operator separately to output locations of the output branches of the concatenation layer. Herein, N is a positive integer greater than 1, and may be, for example, 2 In one embodiment.

When an initial model is subsequently quantized, a quantization priority of a specified network layer for a service object has a highest quantization priority. For example, if a service configuration of the service object for the initial model includes a specified network layer (for example, an activation layer) that does not participate in quantization, the computer device may first filter out a quantization rule (for example, the quantization rule R3 and the quantization rule R4) corresponding to a to-be-quantized structure including the specified network layer, to obtain a filtered first rule set, and then detect, based on the filtered first rule set, whether an accelerable to-be-quantized structure (that is, a target structure the same as the five structures after filtering) exists in a model structure diagram of the initial model.

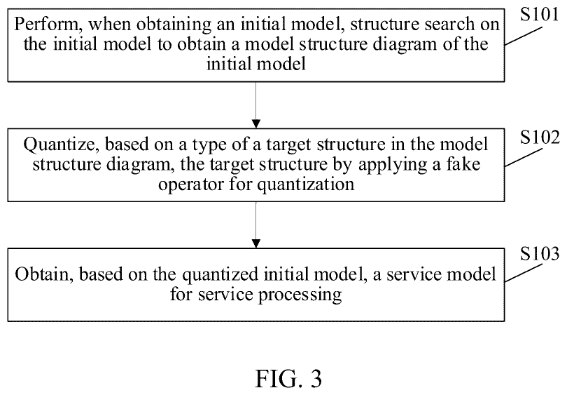

For a specific implementation in which the computer device with the model quantization function automatically quantizes, based on a general quantization tool, the accelerable to-be-quantized structure existing in the initial model, refer to the following embodiments corresponding to FIG. 3 to FIG. 15.

Further, FIG. 3 is a schematic flowchart of a data processing method according to an embodiment of the present disclosure. As shown in FIG. 3, the method may be performed by a computer device with a model quantization function. The computer device may be a terminal device (for example, any terminal device in the terminal device cluster shown in FIG. 1, for example, the terminal device 100b), or may be a server (for example, the server 10S shown in FIG. 1). This is not limited herein. For ease of understanding, this embodiment of the present disclosure is described by using an example in which the method is performed by the computer device with the model quantization function. The method may include at least the following operation S101 to operation S103:

Operation S101: The computer device performs, when obtaining an initial model, structure search on the initial model to obtain a model structure diagram of the initial model.

Specifically, When obtaining the to-be-optimized initial model, the computer device may invoke a general quantization tool, and perform structure search on the initial model based on a graph search tool in the general quantization tool, to obtain the model structure diagram of the initial model.

Operation S102: The computer device quantizes, based on a type of a target structure in the model structure diagram, the target structure by using a fake operator for quantization.

The fake operator herein may include a quantization operator and a dequantization operator. The type of the target structure herein may be a first structure, a second structure, or a third structure. The first structure herein is a structure including a network layer with a weight. In one embodiment, the network layer with a weight in the target structure of the initial model may be referred to as a first network layer with a weight. The structure G1, the structure G2, the structure G3, the structure G4, and the structure G5 shown in FIG. 2 are all first structures. The second structure herein (for example, the structure G6 shown in FIG. 2) includes an addition layer of which a type of an input branch is a non-weighted operation input type. In one embodiment, the addition layer of which the type of the input branch is the non-weighted operation input type and that is included in the target structure of the initial model may be referred to as a first addition layer. The third structure herein (for example, the structure G7 shown in FIG. 2) includes a concatenation layer whose input branches and output branches are equal in quantity. In one embodiment, the concatenation layer whose of input branches and output branches are equal in quantity and that is included in the target structure of the initial model may be referred to as a first concatenation layer.

The computer device may obtain M general quantization rules pre-designed according to reasoning experience, and then may determine a rule set formed by the M quantization rules as an initial rule set (for example, the rule set 20R shown in FIG. 2). Herein, M may be a positive integer. In addition, the computer device further needs to obtain a service configuration of a service object for the initial model. The service configuration herein is configuration information set by the service object (for example, a user) for the initial model, for example, a service platform on which the initial model is to be subsequently deployed, and a specified network layer that is specified by the service object not to participate in quantization. This is not limited herein. Because the initial rule set includes the M quantization rules, and one quantization rule corresponds to one to-be-quantized structure, the initial rule set is related to M to-be-quantized structures. Further, the computer device may determine, based on the service configuration and the initial rule set, a quantization rule set finally for model quantization.

When the service object specifies a network layer not to participate in quantization, it means that the service configuration includes the specified network layer that does not participate in quantization. In this case, the computer device needs to query the M to-be-quantized structures for the specified network layer, to obtain a query result. If the query result indicates that the M to-be-quantized structures include a to-be-quantized structure including the specified network layer, the computer device may determine the found to-be-quantized structure as a filtered structure, further delete a quantization rule corresponding to the filtered structure from the initial rule set, and determine an initial rule set obtained through deletion as the quantization rule set.

As shown in FIG. 2, if the specified network layer that does not participate in quantization and that is included in the service configuration is an activation layer, the computer device needs to query the activation layer in the seven to-be-quantized structures shown in FIG. 2, to obtain a query result. Because both the structure G3 and the structure G4 shown in FIG. 2 include the activation layer, the query result indicates that the seven to-be-quantized structures include the to-be-quantized structure including the specified network layer. In this case, the computer device may determine the structure G3 and the structure G4 as filtered structures, then delete, from the rule set 20R, quantization rules (that is, the quantization rule R3 and the quantization rule R4) corresponding to the filtered structures, and further determine a rule set 20R obtained through deletion as the quantization rule set. In this case, the quantization rule set herein may include the quantization rule R1, the quantization rule R2, the quantization rule R5, the quantization rule R6, and the quantization rule R7 shown in FIG. 2.

In some embodiments, when the service object does not specify a network layer that does not participate in quantization, it means that there is no specified network layer in the service configuration. In this case, the computer device may directly determine the initial rule set as the quantization rule set. As shown in FIG. 2, if the service configuration does not include the specified network layer, the computer device may directly determine the rule set 20R shown in FIG. 2 as the quantization rule set. In this case, the quantization rule set herein may include the quantization rule R1, the quantization rule R2, the quantization rule R3, the quantization rule R4, the quantization rule R5, the quantization rule R6, and the quantization rule R7 shown in FIG. 2.

The quantization rule set may include N quantization rules, and one quantization rule corresponds to one to-be-quantized structure. Therefore, the computer device needs to find, from the model structure diagram through depth first search (DFS), all target structures that conform to the N to-be-quantized structures in the quantization rule set, and then may determine, from the N quantization rules based on types of the target structures in the model structure diagram, target quantization rules matching the target structures, determine addition locations of fake operators in the initial model, and further add the fake operators to the determined addition locations, to implement quantization of the target structures.

For example, if the target structure in the model structure diagram includes the first network layer with a weight, the computer device may add the fake operator for quantization to an input location of the first network layer with a weight, and quantize a weight of the first network layer with a weight by using the fake operator.

If the first network layer with a weight has a plurality of output locations, the computer device further needs to add fake operators for quantization separately to the plurality of output locations of the first network layer with a weight.

In other words, if the target structure includes the first network layer with a weight and the first network layer with a weight has the plurality of output locations, the computer device needs to obtain, from the quantization rule set, a quantization rule matching the target structure, and further determine the matching quantization rule (for example, the quantization rule R1 shown in FIG. 2) as the target quantization rule. Then, the computer device may determine the input location of the first network layer with a weight, the output locations of the first network layer with a weight, and a weight location of the first network layer with a weight as addition locations according to the quantization rule R1, and further add the fake operators to the addition locations. The fake operators added to the addition locations may be the same or different. This is not limited herein.

In some embodiments, if the first network layer with a weight has one output location and no activation layer is connected to the output location of the first network layer with a weight, the computer device further needs to add the fake operator for quantization to the output location of the first network layer with a weight.

In some embodiments, if the first network layer with a weight has one output location and the activation layer is connected to the output location of the first network layer with a weight, to reserve high-precision calculation and reduce a precision loss caused by quantization output, the computer device may not add the fake operator for quantization to the output location of the first network layer with a weight.

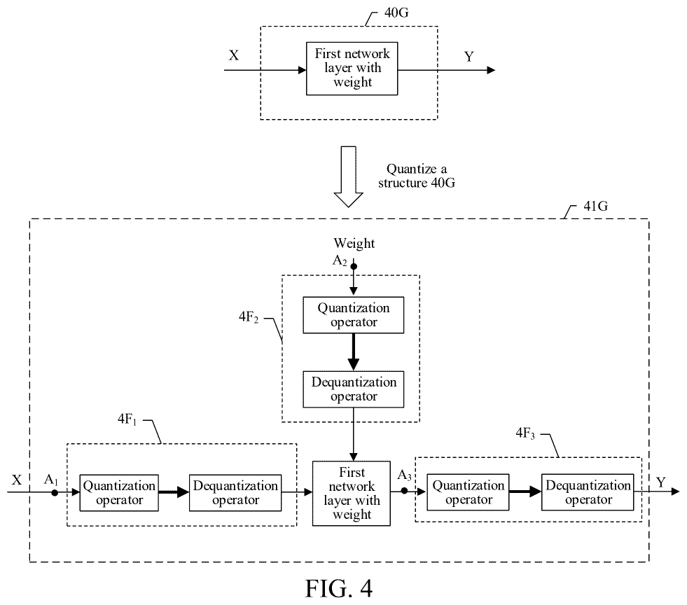

FIG. 4 is a schematic diagram 1 of quantizing a target structure according to an embodiment of the present disclosure. As shown in FIG. 4, a structure 40G may be the target structure found by the computer device from the model structure diagram of the initial model. The structure 40G includes the first network layer with a weight (for example, a convolution layer). The first network layer with a weight has one output location, and no activation layer is connected to the output location.

As shown in FIG. 4, when an input (for example, X) In one embodiment is transmitted to the structure 40G, the first network layer with a weight in the structure 40G may perform feature extraction processing on X to obtain an output of the first network layer with a weight (that is, an output of the structure 40G, for example, Y). If X herein is of first precision, the output of the structure 40G is also of the first precision. Further, when performing quantization on the structure 40G, the computer device may search the quantization rule set for a quantization rule matching the structure 40G, and further determine a found quantization rule as the target quantization rule (for example, the quantization rule R2 shown in FIG. 2).

Based on this, the computer device may determine, according to the target quantization rule, the input location of the first network layer with a weight as a location A1, determine the weight location of the first network layer with a weight as a location A2, and determine the output location of the first network layer with a weight as a location A3, and may further determine the location A1, the location A2, and the location A3 as addition locations of fake operators in the structure 40G.

Further, the computer device may add a fake operator (for example, a fake operator 4F1) to the location A1, so that X is converted to the second precision by using a quantization operator in the fake operator 4F1, and then is restored to the first precision by using a dequantization operator in the fake operator 4F1. Similarly, the computer device may further add a fake operator at the location A2, and quantize the weight of the first network layer with a weight, so that the weight of the first network layer with a weight is converted to the second precision by using a quantization operator in the fake operator 4F2, and then is restored to the first precision by using a dequantization operator in the fake operator 4F2. The computer device may further add a fake operator (for example, a fake operator 4F3) to the location A3, so that the output of the first network layer with a weight is converted to the second precision by using a quantization operator in the fake operator 4F3, and then is restored to the first precision by using a dequantization operator in the fake operator 4F3.

In one embodiment, when the target structure such as the structure 40G is detected, the structure 40G may be automatically quantized by using the quantization rule matching the structure 40G and the fake operators (including the fake operator 4F1, the fake operator 4F2, and the fake operator 4F3), to obtain a quantized structure 40G (for example, a quantized structure 41G shown in FIG. 4).

For another example, as can be known according to reasoning experience, if the target structure in the model structure diagram includes the first network layer with a weight, a normalization layer, and an activation layer that are sequentially connected, and the first network layer with a weight is a convolution layer, such a target structure may be subsequently fused. Therefore, In one embodiment, such a target structure may be further quantized. To be specific, the computer device may obtain a quantization rule matching the target structure from the quantization rule set, and further determine the matching quantization rule (for example, the quantization rule R4 shown in FIG. 2) as the target quantization rule. Then, the computer device may add, based on the quantization rule R4, the fake operator to an input location of the first network layer with a weight, and quantize a weight of the first network layer with a weight by using the quantization operator.

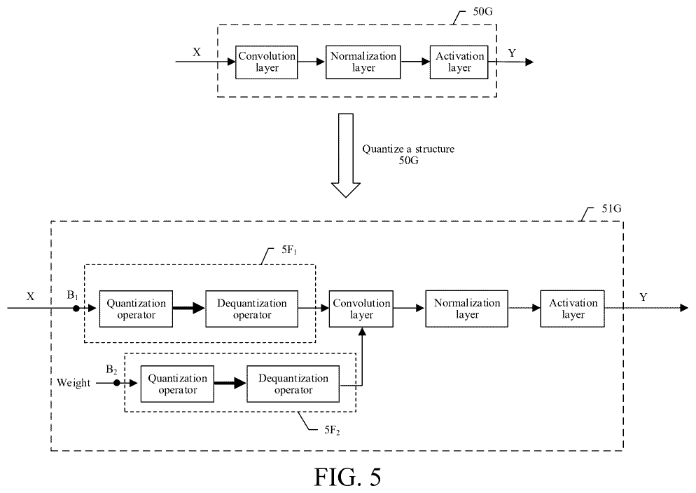

FIG. 5 is a schematic diagram 2 of quantizing a target structure according to an embodiment of the present disclosure. As shown in FIG. 5, a structure 50G may be a target structure found by the computer device from the model structure diagram of the initial model. The structure 50G includes a convolution layer, a normalization layer, and an activation layer that are sequentially connected.

As shown in FIG. 5, when precision of the convolution layer, the normalization layer, and the activation layer in the structure 50G is first precision (for example, FP32), it means that precision of an input (for example, X) and precision of a weight in the convolution layer are also the first precision. In other words, an output (for example, Y) obtained after convolution calculation, normalization calculation, and activation calculation are performed on the input corresponding to the structure 50G is also the first precision. When performing quantization on the structure 50G, the computer device may search, based on a type of the structure 50G, the quantization rule set for a quantization rule matching the structure 50G, and further determine a found quantization rule as the target quantization rule (for example, the quantization rule R4 shown in FIG. 2).

Based on this, the computer device may determine, according to the target quantization rule, an input location of the convolution layer in the structure 50G as a location B1, and determine a weight location of the convolution layer in the structure 50G as a location B2, and may further determine the location B1 and the location B2 as addition locations of fake operators in the structure 50G.

Further, the computer device may add a fake operator (for example, a fake operator 5F1) to the location B1, so that the input of the first precision is converted to second precision by using a quantization operator in the fake operator 5F1, and then is restored to the first precision by using a dequantization operator in the fake operator 5F1. In addition, the computer device may further quantize the weight of the convolution layer by using a fake operator 5F2, that is, add the fake operator 5F2 to the location B2, so that the weight of the first precision is converted to the second precision by using a quantization operator in the fake operator 5F2, and then is restored to the first precision by using a dequantization operator in the fake operator 5F2. The fake operator 5F1 and the fake operator 5F2 herein may be the same or different. This is not limited herein.

In one embodiment, when the target structure such as the structure 50G is detected, the structure 50G may be automatically quantized by using the quantization rule matching the structure 50G and the fake operators (including the fake operator 5F1 and the fake operator 5F2), to obtain a quantized structure 50G (for example, a quantized structure 51G shown in FIG. 5).

For another example, if the target structure in the model structure diagram includes an addition layer, a first input branch of the addition layer, and a second input branch of the addition layer, the computer device may add the fake operator to an output location of the addition layer, or may add the fake operator to an input location of the second input branch. The first input branch herein includes the first network layer with a weight and a normalization layer that are sequentially connected. The normalization layer is connected to the addition layer. A type of the second input branch is a non-weighted operation input type. The first network layer with a weight is a convolution layer.

In other words, if the first network layer with a weight included in the target structure in the model structure diagram is a convolution layer, an output location of the convolution layer is connected to the normalization layer, and an output location of the normalization layer is connected to the addition layer, the computer device not only needs to add a fake operator for quantization to an input location of the first network layer with a weight and quantize a weight of the first network layer with a weight by using the fake operator, but also needs to add a fake operator to the output location of the addition layer. In addition, because precision of the second input branch determines output precision of a fused network layer with a weight, to improve a speed, the computer device may further add the fake operator to the input location of the second input branch.

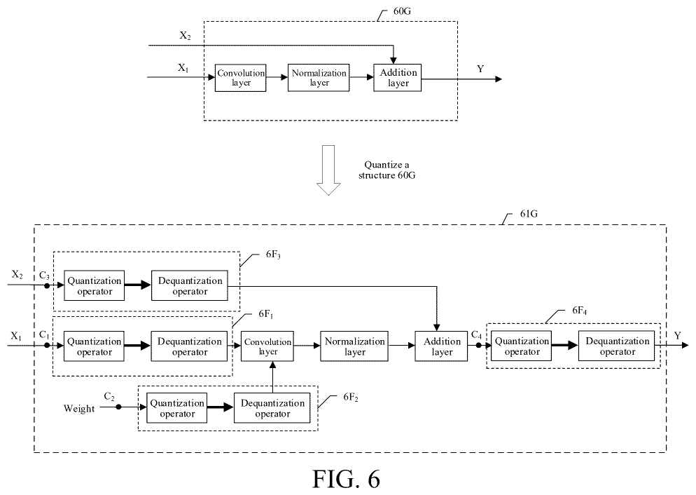

FIG. 6 is a schematic diagram 3 of quantizing a target structure according to an embodiment of the present disclosure. As shown in FIG. 6, a structure 60G may be a target structure found by the computer device from the model structure diagram of the initial model. The structure 60G is a skip connection structure associated with an addition layer. A first input branch of the addition layer may include a convolution layer and a normalization layer that are sequentially connected. A type of a second input branch is a non-weighted operation input type. In other words, an input X2 corresponding to the second input branch may be an input of a non-weighted operation.

As shown in FIG. 6, the addition layer in the structure 60G may add a first input (for example, X1) and a second input (for example, X2) obtained through convolution calculation and normalization calculation, to obtain an output (for example, Y) of the structure 60G. Because both the first input and the second input are of first precision, the output of the structure 60G is also of the first precision. When performing quantization on the structure 60G, the computer device may search the quantization rule set for a quantization rule matching the structure 60G, and further determine a found quantization rule as the target quantization rule (for example, the quantization rule R5 shown in FIG. 2).

Based on this, to implement a subsequent model processing speed, the computer device may determine, according to the target quantization rule, an input location of the convolution layer in the structure 60G as a location C1, determine a weight location of the convolution layer as a location C2, determine an input location of the second input branch as a location C3, and determine an output location of the addition layer as a location C4, and may further determine the location C1, the location C2, the location C3, and the location C4 as addition locations of fake operators in the initial model.

Further, the computer device may add a fake operator (for example, a fake operator 6F1) to the location C1, so that the first input (for example, X1) of the first precision is converted to second precision by using a quantization operator in the fake operator 6F1, and then is restored to the first precision by using a dequantization operator in the fake operator 6F1. Similarly, the computer device may further add a fake operator (for example, a fake operator 6F2) to the location C2, and quantize a weight of the convolution layer by using the fake operator 6F2, so that the weight of the first precision is converted to the second precision by using a quantization operator in the fake operator 6F2, and then is restored to the first precision by using a dequantization operator in the fake operator 6F2. The computer device may further add a fake operator (for example, a fake operator 6F3) to the location C3, so that the second input (for example, X2) of the first precision is converted to the second precision by using a quantization operator in the fake operator 6F3, and then is restored to the first precision by using a dequantization operator in the fake operator 6F3. The computer device may further add a fake operator (for example, a fake operator 6F4) to the location C4, so that an output of the addition layer is converted to the second precision by using a quantization operator in the fake operator 6F4, and then is restored to the first precision by using a dequantization operator in the fake operator 6F4. The fake operators added to the addition locations herein may be the same or different. This is not limited herein.

In one embodiment, when the target structure such as the structure 60G is detected, the structure 60G may be automatically quantized by using the quantization rule matching the structure 60G and the fake operators (including the fake operator 6F1, the fake operator 6F2, the fake operator 6F3, and the fake operator 6F4), to obtain a quantized structure 60G (for example, a quantized structure 61G shown in FIG. 6).

For another example, if the target structure in the model structure diagram includes a first addition layer and a type of a first input branch of the first addition layer and a type of a second input branch of the first addition layer are both a non-weighted operation input type, the computer device needs to add a fake operator for quantization to an input location of the first input branch, add a fake operator to an input location of the second input branch, and add a fake operator to an output location of the first addition layer.

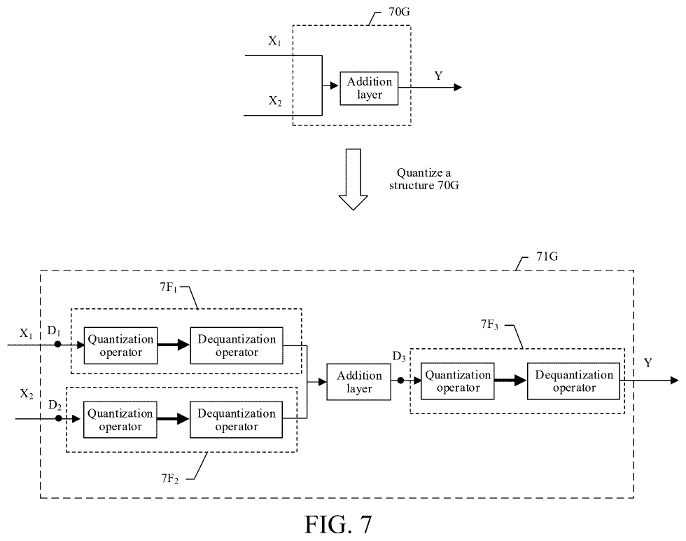

FIG. 7 is a schematic diagram 4 of quantizing a target structure according to an embodiment of the present disclosure. As shown in FIG. 7, a structure 70G may be a target structure found by the computer device from the model structure diagram of the initial model. The structure 70G may include an addition layer with two input branches and one output branch.

As shown in FIG. 7, when two inputs (for example, X1 and X2) In one embodiment are transmitted to the structure 70G, the addition layer in the structure 70G may add X1 and X2 to obtain an output of the addition layer (that is, an output of the structure 70G, for example, Y). If both X1 and X2 herein are of first precision, the output of the structure 70G is also of the first precision. When performing quantization on the structure 70G, the computer device may search the quantization rule set for a quantization rule matching the structure 70G, and further determine a found quantization rule as the target quantization rule for performing quantization on the structure 70G (for example, the quantization rule R6 shown in FIG. 2).

Based on this, the computer device may determine, according to the target quantization rule, an input location of the first input branch of the addition layer (that is, an input location of X1) as a location D1, determine an input location of the second input branch of the addition layer (that is, an input location of X2) as a location D2, and determine an output location of the addition layer as a location D3, and may further determine the location D1, the location D2, and the location D3 as addition locations of fake operators in the structure 70G.

Further, the computer device may add a fake operator (for example, a fake operator 7F1) to the location D1, so that the first input (for example, X1) input to the structure 70G is converted to second precision by using a quantization operator in the fake operator 7F1, and then is restored to the first precision by using a dequantization operator in the fake operator 7F1. Similarly, the computer device may further add a fake operator (for example, a fake operator 7F2) to the location D2, so that the second input (for example, X2) input to the structure 70G is converted to the second precision by using a quantization operator in the fake operator 7F2, and then is restored to the first precision by using a dequantization operator in the fake operator 7F2. The computer device may further add a fake operator (for example, a fake operator 7F3) to the location D3, so that the output of the addition layer is converted to the second precision by using a quantization operator in the fake operator 7F3, and then is restored to the first precision by using a dequantization operator (for example, a dequantization operator 2) in the fake operator 7F3.

In one embodiment, when the target structure such as the structure 70G is detected, the structure 70G may be automatically quantized by using the quantization rule matching the structure 70G and the fake operators (including the fake operator 7F1, the fake operator 7F2, and the fake operator 7F3), to obtain a quantized structure 70G (for example, a quantized structure 71G shown in FIG. 7).

For another example, if the target structure in the model structure diagram includes a first concatenation layer and a quantity of input branches of the first concatenation layer is the same as a quantity of output branches of the first concatenation layer, the computer device may add a fake operator for quantization to an output location of each of N output branches of the first concatenation layer. Herein, N may be a positive integer greater than 1. To subsequently optimize the structure, quantization operators of fake operators added to the output branches herein are the same.

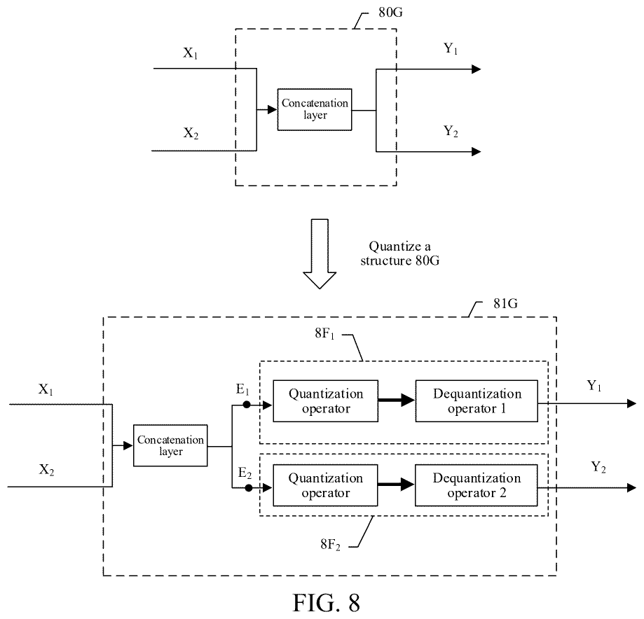

FIG. 8 is a schematic diagram 5 of quantizing a target structure according to an embodiment of the present disclosure. As shown in FIG. 8, a structure 80G may be a target structure found by the computer device from the model structure diagram of the initial model. The structure 80G may include a concatenation layer, and a quantity of input branches of the concatenation layer is the same as a quantity of output branches. For ease of description, In one embodiment, two input branches and two output branches may be used as an example.

As shown in FIG. 8, the concatenation layer in the structure 80G may concatenate inputs (for example, X1 and X2) of the two input branches to obtain outputs (for example, Y1 and Y2) of the concatenation layer. If both X1 and X2 herein are of first precision, both outputs of the structure 80G are of the first precision. When performing quantization on the structure 80G, the computer device may search the quantization rule set for a quantization rule matching the structure 80G, and further determine a found quantization rule as the target quantization rule (for example, the quantization rule R7 shown in FIG. 2).

Based on this, the computer device may determine, according to the target quantization rule, an output location of a first output branch of the concatenation layer as a location E1, and determine an output location of a second output branch of the concatenation layer as a location D2, and may further determine the location E1 and the location E2 as addition locations of fake operators in the structure 80G.

Further, the computer device may add a fake operator (for example, a fake operator 8F1) to the location E1, so that a first output of the concatenation layer is converted to second precision by using a quantization operator in the fake operator 8F1, and then is restored to the first precision by using a dequantization operator (for example, a dequantization operator 1) in the fake operator 8F1. Similarly, the computer device may further add a fake operator (for example, a fake operator 8F2) to the location E2, so that a second output of the concatenation layer is converted to the second precision by using a quantization operator in the fake operator 8F2, and then is restored to the first precision by using a dequantization operator (for example, a dequantization operator 2) in the fake operator 8F2. Quantization operators in the fake operator 8F1 and the fake operator 8F2 are the same, and dequantization operators in the fake operator 8F1 and the fake operator 8F2 may be the same or different. This is not limited herein.

In one embodiment, when the target structure such as the structure 80G is detected, the structure 80G may be automatically quantized by using the quantization rule matching the structure 80G and the fake operators (including the fake operator 8F1 and the fake operator 8F2), to obtain a quantized structure 80G (for example, a quantized structure 81G shown in FIG. 8).

Operation S103: The computer device obtains, based on a quantized initial model, a service model for service processing.

Specifically, the computer device may separately perform quantization on various accelerable to-be-quantized structures existing in the model structure diagram. After ending quantization, the computer device may determine the quantized initial model as a first model. To ensure that precision of the quantized model meets a service requirement, the computer device may further perform fine-tuning training on the first model to obtain a second model, and further obtain, based on the second model, the service model for service processing.

When performing fine-tuning training on the first model, the computer device may obtain sample service data and a sample service label corresponding to the sample service data, further input a sample feature of the sample service data to the first model, and predict the sample service data by using a fake operator added to the first model and each network layer in the first model, to obtain a predicted service label of the sample service data. In this case, the computer device may perform fine-tuning training on the first model based on the sample service label and the predicted service label, to obtain the second model, and then perform optimization processing on the second model to obtain the service model for service processing.

The sample service data herein is determined based on service processing performed by the initial model. For example, if service processing of the initial model is key part detection (for example, face detection) processing, the sample service data herein may be a face/non-face training set generated by performing partial segmentation, reversal, Gaussian blurring, or the like on an obtained face image in a face database (for example, a face dataset (Annotated Facial Landmarks in the Wild)). In this case, the sample service label herein may be configured for indicating a true class (for example, human face or non-human face) of the sample service data.

This embodiment of the present disclosure relates to a face (or another biological feature) recognition technology. When the foregoing embodiment of the present disclosure is applied to a specific product or technology, collection, use, and processing of related data need to comply with national legal and legal requirements. Before face information is collected, an information processing rule needs to be notified and individual consent of a target object needs to be solicited. The face information is processed strictly according to the legal and legal requirements and personal information processing rules, and technical measures are taken to ensure security of the related data.

For another example, if service processing of the initial model is content review processing, the sample service data herein may be obtained multimedia data (for example, a video, an audio, a text, or an image). In this case, the sample service label herein may be configured for indicating true impact degree of content quality of the sample service data. A higher impact degree indicates higher content quality of the sample service data.

For another example, if service processing of the initial model is image recognition processing, the sample service data herein may be obtained image data. In this case, the sample service label herein may be configured for indicating a true class (for example, human, cat, or dog) of the sample service data. Certainly, service processing of the initial model may further include other processing, which is not exemplified herein.

In the present disclosure, a related data capturing technical solution is implemented (for example, multimedia data is captured during content review processing or image data is captured during image recognition processing). When the foregoing embodiment of the present disclosure is applied to a specific product or technology, collection, use, and processing of a related data need to comply with national legal and legal requirements, satisfy legal, justified, and necessary principles, do not relate to obtaining a data type prohibited or limited by the legal and legal regulations, and does not interfere with normal running of a target website.

When a network structure of the second model is complex, In one embodiment, optimization processing needs to be performed on a to-be-optimized structure in the second model, so that as many operators as possible in the second model are fused to obtain the service model. The second model is the quantized initial model obtained through fine-tuning training. Therefore, both a model structure diagram of the second model and a model structure diagram of the first model are the same as the model structure diagram of the initial model. In one embodiment, a network layer with a weight in the second model may also be referred to as a first network layer with a weight. By analogy, an addition layer of which a type of an input branch is the non-weighted operation input type in the second model is referred to as a first addition layer, and a concatenation layer whose input branches and output branches are equal in quantity in the second model is referred to as a first concatenation layer.

For example, if the target structure of the initial model includes the first network layer with a weight, the to-be-optimized structure in the second model also includes the first network layer with a weight. In this case, the service model finally obtained based on the second model may include a network layer (that is, second network layer) with a weight and a quantization operator added to an input location of the second network layer with a weight. The second network layer with a weight in the service model is obtained based on the first network layer with a weight. A weight of the second network layer with a weight is obtained by processing the weight of the first network layer with a weight in the second model by using the quantization operator.

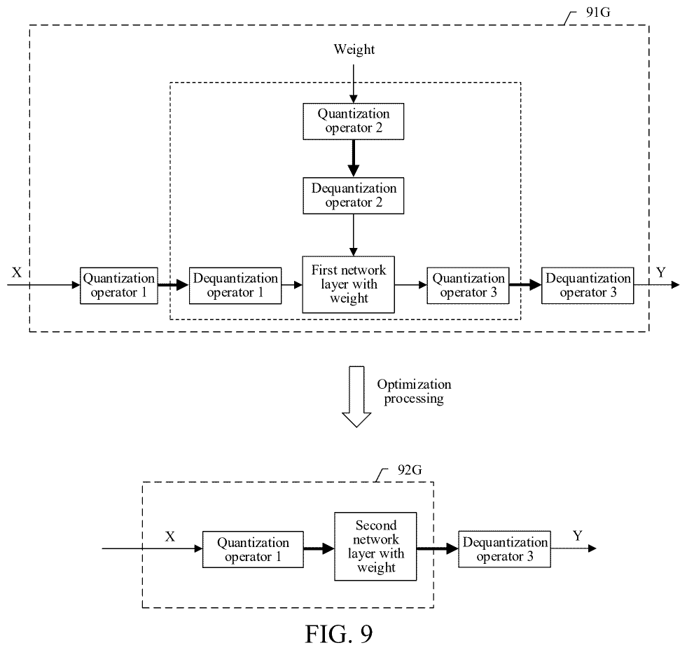

FIG. 9 is a schematic diagram 1 of processing a to-be-optimized structure in the second model according to an embodiment of the present disclosure. As shown in FIG. 9, a structure 91G herein may be a to-be-optimized structure in the second model. The structure 91G is obtained by the computer device by quantizing the target structure in the initial model and performing fine-tuning training. The structure 91G is structurally the same as the structure 41G shown in FIG. 4.

The structure 91G may include a fake operator F1 (that is, a fake operator including a quantization operator 1 and the dequantization operator 1), a fake operator F2 (that is, a fake operator including a quantization operator 2 and the dequantization operator 2), and a fake operator F3 (that is, a fake operator including a quantization operator 3 and a dequantization operator 3).

When performing optimization processing on the structure 91G, the computer device may obtain the second network layer with a weight based on the first network layer with a weight in the structure 91G, and further process the weight of the first network layer with a weight in the structure 91G by using the quantization operator, to obtain the weight of the second network layer with a weight. For example, the computer device may filter out the dequantization operator 1 and the dequantization operator 2, and process the weight of the first network layer with a weight in the structure 91G by using the quantization operator 2 and the quantization operator 3, to obtain the weight of the second network layer with a weight.

This means that after the computer device performs optimization processing on the structure 91G in the second model, an optimized structure (that is, a structure 92G shown in FIG. 9) in the service model may be obtained. As shown in FIG. 9, the structure 92G may include the second network layer with a weight and a quantization operator (for example, the quantization operator 1) added to the input location of the second network layer with a weight.

For another example, if the first network layer with a weight in the target structure of the initial model is the convolution layer and the target structure further includes the normalization layer connected to the convolution layer and the activation layer connected to the normalization layer, the computer device further needs to fuse the first network layer with a weight, the normalization layer, and the activation layer to obtain a second network layer with a weight.

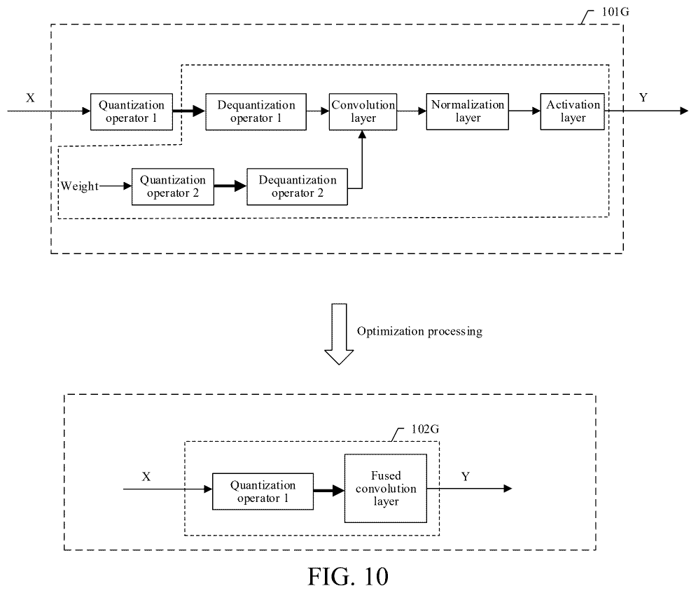

FIG. 10 is a schematic diagram 2 of processing a to-be-optimized structure in the second model according to an embodiment of the present disclosure. As shown in FIG. 10, a structure 101G herein may be a to-be-optimized structure in the second model. The structure 101G is obtained by the computer device by quantizing the target structure in the initial model and performing fine-tuning training. The first network layer with a weight in the target structure herein is the convolution layer. The target structure further includes the normalization layer connected to the convolution layer and the activation layer connected to the normalization layer. The structure 101G is structurally the same as the structure 51G shown in FIG. 5.

The structure 101G may include a fake operator F1 (that is, a fake operator including a quantization operator 1 and the dequantization operator 1) and a fake operator F2 (that is, a fake operator including a quantization operator 2 and the dequantization operator 2). When performing optimization processing on the structure 101G, the computer device may obtain a fused convolution layer in a structure 102G based on the convolution layer in the structure 101G. For example, the computer device may fuse the convolution layer, the normalization layer, and the activation layer in the structure 101G, to obtain the fused convolution layer (that is, the second network layer with a weight).

In addition, the computer device may further process a weight of the convolution layer in the structure 101G by using the quantization operator, to obtain a weight of the fused convolution layer. For example, the computer device may filter out the dequantization operator 1 and the dequantization operator 2, and process the weight of the convolution layer in the structure 101G by using the quantization operator 2, to obtain the weight of the fused convolution layer.

This means that after the computer device performs optimization processing on the structure 101G in the second model, an optimized structure (that is, the structure 102G shown in FIG. 10) in the service model may be obtained. As shown in FIG. 10, the structure 102G may include the second network layer with a weight and a quantization operator (for example, the quantization operator 1) added to an input location of the second network layer with a weight.

For another example, if the target structure of the initial model includes the addition layer, the first input branch of the addition layer, and the second input branch of the addition layer, and the first input branch includes the first network layer with a weight and the normalization layer that are sequentially connected, the computer device may further fuse the first network layer with a weight, the normalization layer, and the addition layer, to obtain a second network layer with a weight. Herein, the normalization layer is connected to the addition layer. The type of the second input branch is the non-weighted operation input type. The first network layer with a weight is the convolution layer.

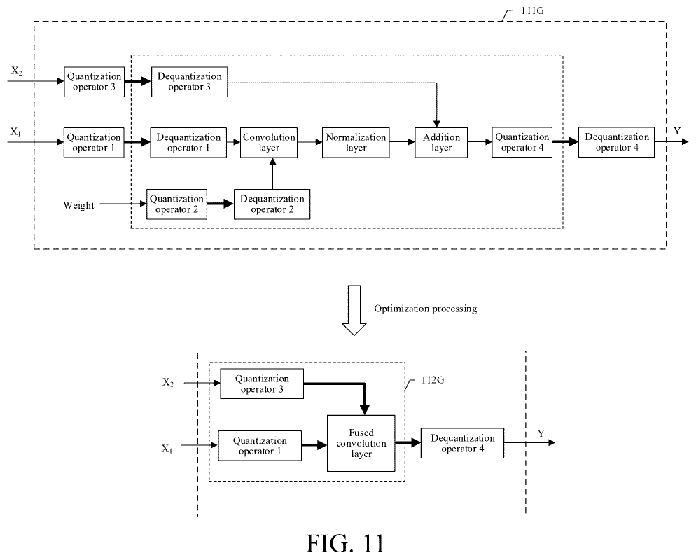

FIG. 11 is a schematic diagram 3 of processing a to-be-optimized structure in the second model according to an embodiment of the present disclosure. As shown in FIG. 11, a structure 111G herein may be a to-be-optimized structure in the second model. The structure 111G is obtained by the computer device by quantizing the target structure in the initial model and performing fine-tuning training. The target structure herein includes the addition layer, the first input branch of the addition layer, and the second input branch of the addition layer. The first input branch includes the first network layer with a weight and the normalization layer that are sequentially connected. The first network layer with a weight is the convolution layer. The normalization layer is connected to the addition layer. The type of the second input branch is the non-weighted operation input type. The structure 111G is structurally the same as the structure 61G shown in FIG. 6.

The structure 111G may include a fake operator F1 (that is, a fake operator including a quantization operator 1 and the dequantization operator 1), a fake operator F2 (that is, a fake operator including a quantization operator 2 and the dequantization operator 2), a fake operator F3 (that is, a fake operator including a quantization operator 3 and a dequantization operator 3), and a fake operator F4 (that is, a fake operator including a quantization operator 4 and a dequantization operator 4).

When performing optimization processing on the structure 111G, the computer device may obtain a fused convolution layer in a structure 112G based on the convolution layer in the structure 111G. For example, the computer device may fuse the convolution layer, the normalization layer, and the activation layer in the structure 111G, to obtain the fused convolution layer (that is, the second network layer with a weight).

In addition, the computer device may further process a weight of the convolution layer in the structure 111G by using the quantization operator, to obtain a weight of the fused convolution layer. For example, the computer device may filter out the dequantization operator 1, the dequantization operator 2, and the dequantization operator 3, and process the weight of the convolution layer in the structure 111G by using the quantization operator 2 and the quantization operator 4, to obtain the weight of the fused convolution layer.

This means that after the computer device performs optimization processing on the structure 111G in the second model, an optimized structure (that is, the structure 112G shown in FIG. 11) in the service model may be obtained. As shown in FIG. 11, the structure 112G may include the second network layer with a weight and a quantization operator (for example, the quantization operator 1 and the quantization operator 3) added to an input location of the second network layer with a weight.

For another example, if the target structure of the initial model includes the first addition layer, and the type of the first input branch of the first addition layer and the type of the second input branch of the first addition layer are both non-weighted operation input types, the service model finally obtained based on the second model may include a second addition layer, a quantization operator added to a first input branch of the second addition layer, and a quantization operator added to a second input branch of the second addition layer. The second addition layer in the service model is obtained based on the quantization operator and the first addition layer in the target structure.

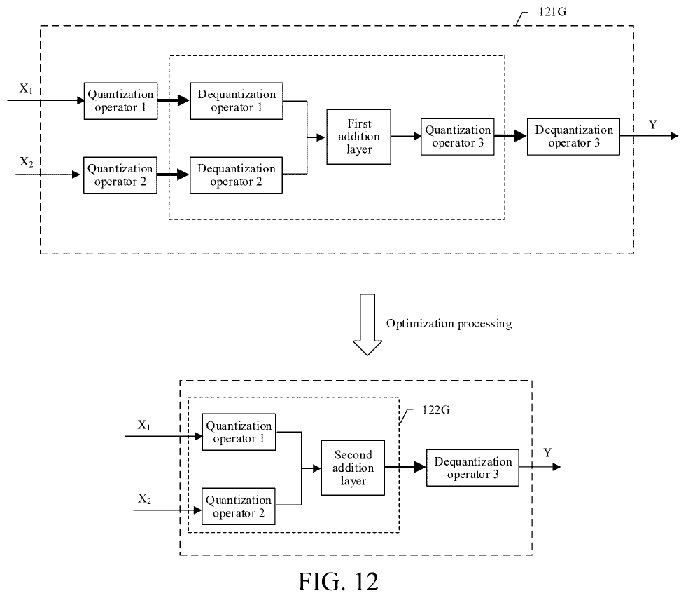

FIG. 12 is a schematic diagram 4 of processing a to-be-optimized structure in the second model according to an embodiment of the present disclosure. As shown in FIG. 12, a structure 121G herein may be a to-be-optimized structure in the second model. The structure 121G is obtained by the computer device by quantizing the target structure in the initial model and performing fine-tuning training. The target structure herein includes the first addition layer, and the type of the first input branch of the first addition layer and the type of the second input branch of the first addition layer are both the non-weighted operation input type. The structure 121G may be structurally the same as the structure 71G shown in FIG. 7.

The structure 121G may include a fake operator F1 (that is, a fake operator including a quantization operator 1 and the dequantization operator 1), a fake operator F2 (that is, a fake operator including a quantization operator 2 and the dequantization operator 2), and a fake operator F3 (that is, a fake operator including a quantization operator 3 and a dequantization operator 3). When performing optimization processing on the structure 121G, the computer device may obtain the second addition layer in a structure 122G based on the quantization operator and the first addition layer in the structure 121G. For example, the computer device may filter out the dequantization operator 1 and the dequantization operator 2, and process the first addition layer by using the quantization operator 3, to obtain the second addition layer.

This means that after the computer device performs optimization processing on the structure 121G in the second model, an optimized structure (that is, the structure 122G shown in FIG. 12) in the service model may be obtained. As shown in FIG. 12, the structure 122G may include the second addition layer, the quantization operator (that is, the quantization operator 1) added to the first input branch of the second addition layer, and the quantization operator (that is, the quantization operator 2) added to the second input branch of the second addition layer.

In one embodiment, locations of the quantization operator and the dequantization operator may be properly changed according to an equivalent propagation rule, to fuse a plurality of operators of a to-be-optimized model as many as possible. In short, the dequantization operator needs to be deferred as much as possible, to defer a dequantization operation, and the quantization operator needs to be advanced as much as possible, to advance a quantization operation. In this way, a parameter is propagated in as many network layers as possible in the model in a low-precision form, improving a model speed.

Based on this, if the target structure of the initial model includes the first concatenation layer and the quantity of input branches of the first concatenation layer is the same as the quantity of output branches of the first concatenation layer, the service model finally obtained based on the second model may include a second concatenation layer and a quantization operator added to an input location of each input branch of the second concatenation layer. The quantization operator added to the input location of each input branch of the second concatenation layer in the service model is obtained by equivalently propagating the quantization operator added to the output location of each output branch of the first concatenation layer in the second model forward to an input location of each input branch of the first concatenation layer in the second model.

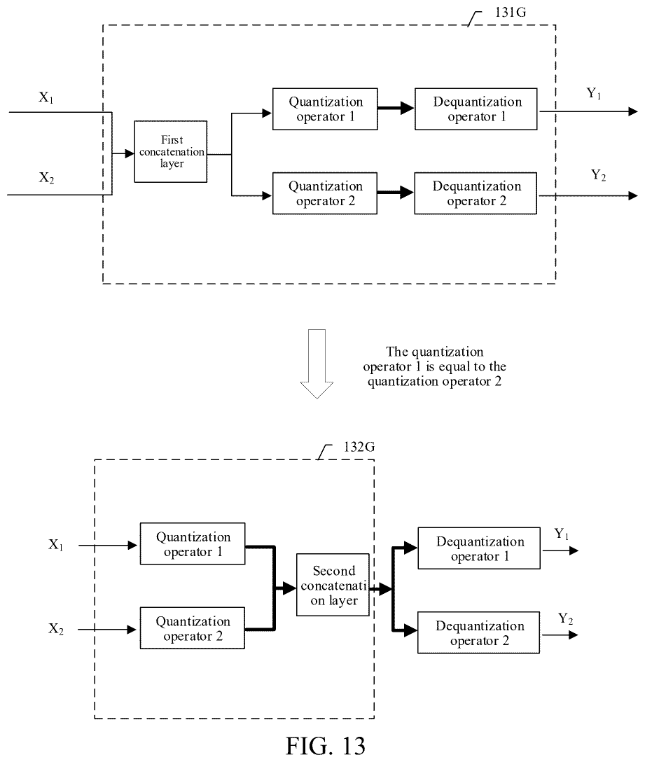

FIG. 13 is a schematic diagram 5 of processing a to-be-optimized structure in the second model according to an embodiment of the present disclosure. As shown in FIG. 13, a structure 131G herein may be a to-be-optimized structure in the second model. The structure 131G is obtained by the computer device by quantizing the target structure in the initial model. The target structure may include the first concatenation layer, and the quantity of input branches of the first concatenation layer is the same as the quantity of output branches of the first concatenation layer. For example, the quantity is two. The structure 131G is structurally the same as the structure 81G shown in FIG. 8.

The structure 131G may include a fake operator F1 (that is, a fake operator including a quantization operator 1 and the dequantization operator 1) and a fake operator F2 (that is, a fake operator including a quantization operator 2 and the dequantization operator 2). Herein, the quantization operator 1 is equal to the quantization operator 2.

Based on this, when performing optimization processing on the structure 131G, the computer device may equivalently propagate a location of the quantization operator 1 forward from a first output location of the first concatenation layer to a first input location (that is, an input location corresponding to X1) of the first concatenation layer. Similarly, the computer device further needs to equivalently propagate a location of the quantization operator 2 forward from a second output location of the first concatenation layer to a second input location (that is, an input location corresponding to X2) of the first concatenation layer. Therefore, a structure 132G may be obtained. In this case, the computer device may refer to a concatenation layer in the structure 132G as the second concatenation layer.

This means that after the computer device performs optimization processing on the structure 131G in the second model, an optimized structure (that is, the structure 132G shown in FIG. 13) in the service model may be obtained. As shown in FIG. 13, the structure 132G may include the second concatenation layer and a quantization operator added to an input location of each input branch of the second concatenation layer. In the structure 132G, the computer device may convert precision of X1 from the first precision to the second precision by using the quantization operator 1, and convert precision of X2 from the first precision to the second precision by using the quantization operator 2, and may further concatenate X1 of the second precision and X2 of the second precision by using the second concatenation layer in the structure 132G, so that a parameter obtained through subsequent concatenation is also of the second precision.

In one embodiment, the service object corresponding to the initial model does not need to manually add the fake operator to a corresponding location in the initial model, and instead, directly submits any initial model to the computer device, so that the computer device invokes a general quantization tool to obtain a preset quantization rule set, and quantizes, based on the general quantization tool and the quantization rule set, an accelerable to-be-quantized structure existing in the initial model. An entire quantization process may be completed inside the general quantization tool. Therefore, labor costs can be effectively reduced, a model quantization speed is improved, and generality of quantization is achieved. In addition, because the general quantization tool further supports fine-tuning training on the quantized initial model, the subsequently obtained service model can obtain a highest acceleration ratio while satisfying a service indicator. In addition, because optimization processing is performed on the to-be-optimized structure in the second model, a query per second (QPS) rate of the subsequently obtained service model can be improved, and occupation of internal memory, video memory, and the like during model deployment can be reduced.

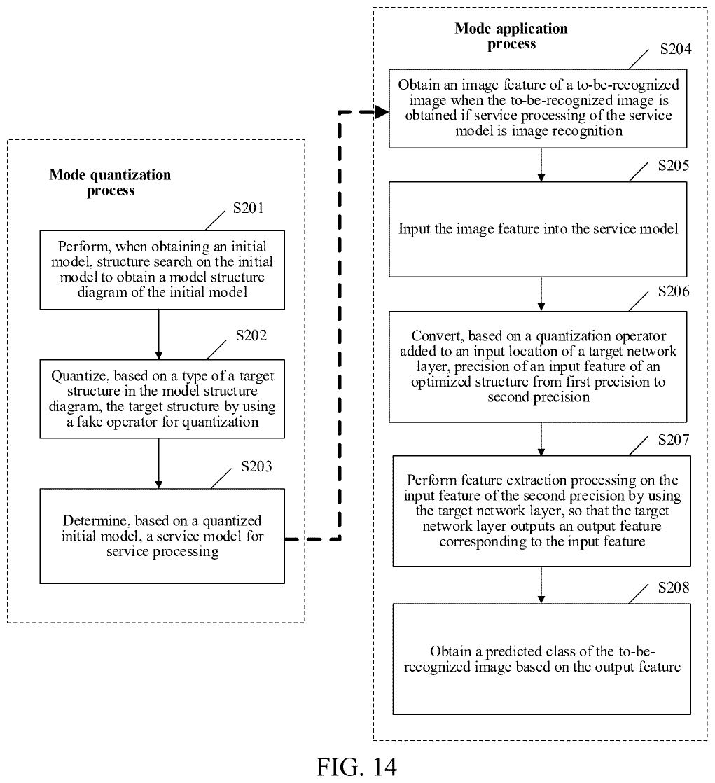

Further, FIG. 14 is a schematic flowchart of a data processing method according to an embodiment of the present disclosure. The method may be performed by a terminal device with a model quantification function (for example, any terminal device in the terminal device cluster shown in FIG. 1, for example, the terminal device 100a), may be performed by a server with a model quantification function (for example, the server 10S shown in FIG. 1), or may be interactively performed by a terminal device with a model application function and a server with a model quantification function. This is not limited herein. The method may include at least the following operation S201 to operation S208:
Operation S201: Perform, when obtaining an initial model, structure search on the initial model to obtain a model structure diagram of the initial model.
Operation S202: Quantize, based on a type of a target structure in the model structure diagram, the target structure by using a fake operator for quantization.

The fake operator includes a quantization operator and a dequantization operator.
Operation S203: Determine, based on a quantized initial model, a service model for service processing.

The data processing method In one embodiment may include a model quantization process and a model application process. Operation S201 to operation S203 describe the model quantization process. For a specific implementation of the model quantization process, refer to the descriptions of operation S101 to operation S103 in the embodiment corresponding to FIG. 3. Details are not described herein again.

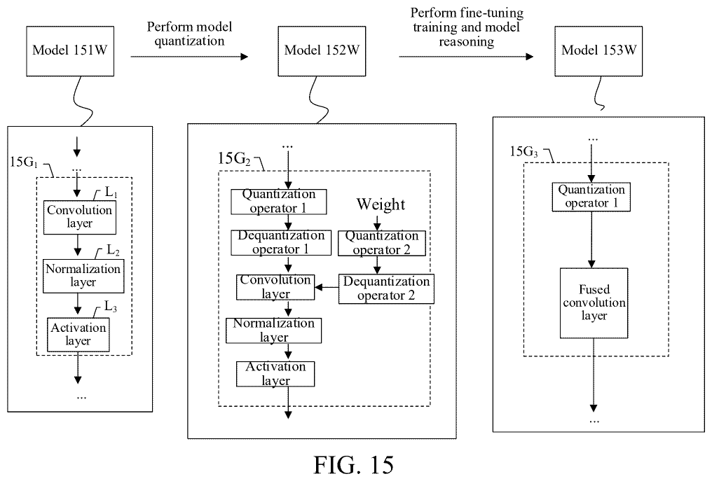

FIG. 15 is a schematic diagram of a scenario of performing model optimization on the service model according to an embodiment of the present disclosure. A computer device In one embodiment may be a computer device with a model quantification function. The computer device may be any terminal device in the terminal device cluster shown in FIG. 1, for example, the terminal device 100b. The computer device may alternatively be the server 10S shown in FIG. 1. The computer device is not limited herein.

A model 151W shown in FIG. 15 is an initial model obtained by the computer device. When obtaining the model 151W shown in FIG. 15, the computer device may invoke a general quantization tool to perform structure search on the model 151W, to obtain a model structure diagram of the model 151W. Further, the computer device may query, based on N to-be-quantized structures corresponding to a preset quantization rule set, the model structure diagram of the model 151W for whether a target structure belonging to the N to-be-quantized structures exists.

Because the structure 15G1 in the model structure diagram of the model 151W is an accelerable to-be-quantized structure, the computer device may determine, from N quantization rules in the quantization rule set, a target quantization rule (for example, the quantization rule R4 shown in FIG. 2) matching the structure 15G1. Further, the computer device may quantize the structure 15G1 based on the target quantization rule and the fake operator, to obtain a quantized target structure (for example, a structure 15G2 shown in FIG. 15). For a specific implementation in which the computer device quantizes the structure 15G1, refer to a specific implementation of quantizing the structure 50G shown in FIG. 5. Details are not described herein again.

After ending quantization, the computer device may obtain a model 152W (that is, a first model) shown in FIG. 15. Further, the computer device may perform fine-tuning training on the model 152W, and further may refer to the model 152W obtained through fine-tuning training as a second model. Then, the computer device may traverse a to-be-optimized structure (that is, a quantized and trained target structure) in the second model, and further obtain an optimized structure based on a quantization operator in the to-be-optimized structure and an original network layer in the to-be-optimized structure. For example, when traversing the structure 15G2 in the second model, the computer device may perform optimization processing on the structure 15G2 with reference to an optimization processing manner shown in FIG. 10, to obtain an optimized structure (for example, a structure 15G3 shown in FIG. 15) corresponding to the structure 15G2.

When completing traversal, the computer device may determine a second model obtained through optimization processing as a third model, and then perform model reasoning on the third model based on a service platform on which the third model is deployed, to obtain the service model (for example, a model 153W shown in FIG. 15) for service processing.

In one embodiment, when the initial model is obtained, optimization processes such as model quantization, fine-tuning training, and model reasoning can be automatically performed on the initial model by using the general quantization tool, so that a query per second of the subsequently obtained service model can be improved, and occupation of internal memory, video memory, and the like during model deployment can be reduced.

The service model herein may be applicable to a plurality of application scenarios. Therefore, service processing of the service model herein may be key part detection processing, content review processing, or image recognition processing. This is not limited herein. For ease of understanding, In one embodiment, image recognition may be used as an example to describe an application process of the service model. For details of the model application process, refer to descriptions of the following operation S204 to operation S208.
Operation S204: Obtain an image feature of a to-be-recognized image when the to-be-recognized image is obtained if service processing of the service model is image recognition.

Specifically, if service processing of the service model is image recognition, when obtaining the to-be-recognized image, the computer device may encode the to-be-recognized image to obtain the image feature of the to-be-recognized image.
Operation S205: Input the image feature into the service model.

Specifically, the computer device may input the image feature of the to-be-recognized image into the service model. The service model herein is a model obtained by performing model quantization, fine-tuning training, and reasoning processing on the high-precision initial model. This means that there is the optimized structure (for example, the structure 15G3 shown in FIG. 15) in the service model. The optimized structure herein includes a target network layer and a quantization operator (for example, a quantization operator 1 before an input location of the structure 15G3 shown in FIG. 15) added to an input location of the target network layer. The target network layer is obtained based on the quantization operator and an original network layer of the target structure in the initial model.
Operation S206: Convert, based on the quantization operator added to the input location of the target network layer, precision of an input feature of the optimized structure from first precision to second precision.

Specifically, the computer device may perform, based on the quantization operator added to the input location of the target network layer, a quantization operation on the input feature of the optimized structure, to convert the precision of the input feature from the first precision to the second precision. The first precision is higher than the second precision. This means that In one embodiment, precision of a parameter input into the optimized structure may be converted from high precision to low precision by using a quantization operator, to achieve an acceleration objective.
Operation S207: Perform feature extraction processing on the input feature of the second precision by using the target network layer, so that the target network layer outputs an output feature corresponding to the input feature.

The output feature of the target network layer is also of the first precision.
Operation S208: Obtain a predicted class of the to-be-recognized image based on the output feature.

Specifically, the computer device may transmit an output feature of the optimized structure (that is, the output feature of the target network layer) to a next network layer of the optimized structure in the service model, until the service model predicts impact degrees of the to-be-recognized image for a plurality of classes, and then a class corresponding to a largest impact degree in the impact degrees for the plurality of classes may be selected as the predicted class of the to-be-recognized image.

For example, if the service model can recognize three classes, specifically including a class 1 (for example, human), a class 2 (for example, cat), and a class 3 (for example, dog), the computer device may predict, by using the service model, that an impact degree of the to-be-recognized image for the class 1 is 15%, an impact degree for the class 2 is 80%, and an impact degree for the class 3 is 5%. Then, the computer device may use the class (that is, the class 2) corresponding to the largest impact degree as the predicted class of the to-be-recognized image.

In one embodiment, a service object corresponding to the initial model does not need to manually add the fake operator to a corresponding location in the initial model, and instead, directly submits any initial model to the computer device, so that the computer device invokes the general quantization tool to obtain a preset quantization rule set, and quantizes, based on the general quantization tool and the quantization rule set, an accelerable to-be-quantized structure existing in the initial model. An entire quantization process may be completed inside the general quantization tool. Therefore, labor costs can be effectively reduced, a model quantization speed is improved, and generality of quantization is achieved. In addition, because the general quantization tool further supports fine-tuning training on the quantized initial model, the subsequently obtained service model can obtain a highest acceleration ratio while satisfying a service indicator, that is, the computer device may perform service processing (for example, image recognition processing) quickly and accurately by using the service model.

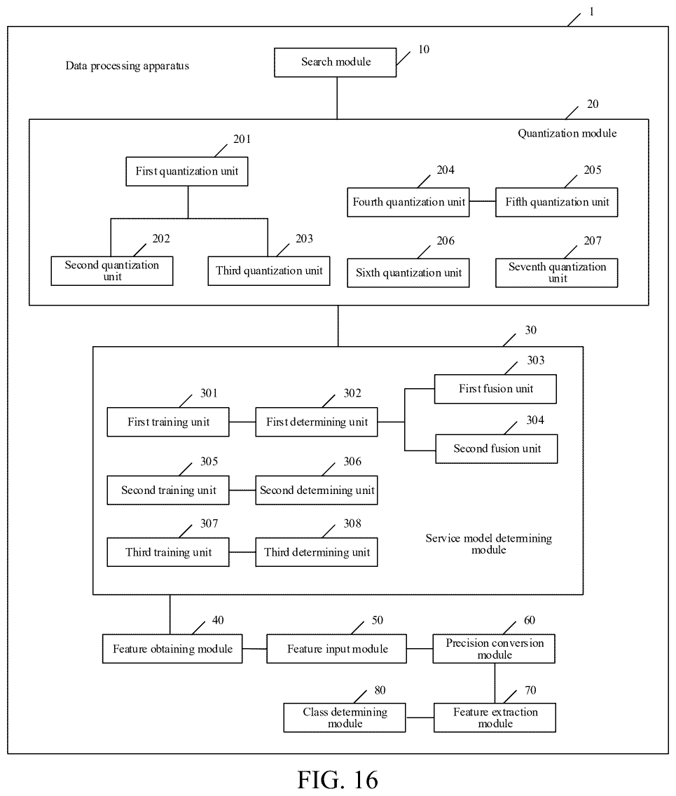

Further, FIG. 16 is a schematic diagram of a structure of a data processing apparatus according to an embodiment of the present disclosure. As shown in FIG. 16, the data processing apparatus 1 may include a search module 10, a quantization module 20, a service model determining module 30, a feature obtaining module 40, a feature input module 50, a precision conversion module 60, a feature extraction module 70, and a class determining module 80.

The search module 10 is configured to perform, when obtaining an initial model, structure search on the initial model to obtain a model structure diagram of the initial model.

The quantization module 20 is configured to quantize, based on a type of a target structure in the model structure diagram, the target structure by using a fake operator for quantization, the fake operator including a quantization operator and a dequantization operator.

The quantization module 20 includes a first quantization unit 201, a second quantization unit 202, a third quantization unit 203, a fourth quantization unit 204, a fifth quantization unit 205, a sixth quantization unit 206, and a seventh quantization unit 207.

The first quantization unit 201 is configured to add, if the target structure in the model structure diagram includes a first network layer with a weight, the fake operator for quantization to an input location of the first network layer with a weight, and quantize a weight of the first network layer with a weight by using the fake operator.

The second quantization unit 202 is configured to add, if the first network layer with a weight has a plurality of output locations, fake operators separately to the plurality of output locations of the first network layer with a weight.

The third quantization unit 203 is configured to add, if the first network layer with a weight has one output location and no activation layer is connected to the output location of the first network layer with a weight, the fake operator for quantization to the output location of the first network layer with a weight.

If the first network layer with a weight has one output location and an activation layer is connected to the output location of the first network layer with a weight, the fake operator for quantization is not added to the output location of the first network layer with a weight.

The fourth quantization unit 204 is configured to add, if the target structure in the model structure diagram includes an addition layer, a first input branch of the addition layer, and a second input branch of the addition layer, the fake operator to an output location of the addition layer.

The first input branch includes the first network layer with a weight and a normalization layer that are sequentially connected. The normalization layer is connected to the addition layer. A type of the second input branch is a non-weighted operation input type. The first network layer with a weight is a convolution layer.

The fifth quantization unit 205 is configured to add the fake operator to an input location of the second input branch.

The sixth quantization unit 206 is configured to add, if the target structure in the model structure diagram includes a first addition layer and a type of a first input branch of the first addition layer and a type of a second input branch of the first addition layer are both a non-weighted operation input type, a fake operator for quantization to an input location of the first input branch, add a fake operator to an input location of the second input branch, and add a fake operator to an output location of the first addition layer.

The seventh quantization unit 207 is configured to add, if the target structure in the model structure diagram includes a first concatenation layer and a quantity of input branches of the first concatenation layer is the same as a quantity of output branches of the first concatenation layer, a fake operator for quantization to an output location of each of N output branches of the first concatenation layer, N being a positive integer greater than 1, and a quantization operator of the fake operator added to each output branch being the same.

For specific implementations of the first quantization unit 201, the second quantization unit 202, the third quantization unit 203, the fourth quantization unit 204, the fifth quantization unit 205, the sixth quantization unit 206, and the seventh quantization unit 207, refer to the specific descriptions of operation S102 in the embodiment corresponding to FIG. 3. Details are not described herein again.

The service model determining module 30 is configured to obtain, based on a quantized initial model, a service model for service processing.

The service model determining module 30 includes a first training unit 301, a first determining unit 302, a first fusion unit 303, a second fusion unit 304, a second training unit 305, a second determining unit 306, a third training unit 307, and a third determining unit 308.

The first training unit 301 is configured to determine the quantized initial model as a first model, and perform fine-tuning training on the first model to obtain a second model.

The first determining unit 302 is configured to obtain, based on the second model, the service model for service processing, the service model including a second network layer with a weight and a quantization operator added to an input location of the second network layer with a weight, the second network layer with a weight in the service model being obtained based on the first network layer with a weight, and a weight of the second network layer with a weight being obtained by processing the weight of the first network layer with a weight in the second model by using the quantization operator.

The first network layer with a weight in the target structure is a convolution layer. The target structure further includes a normalization layer connected to the convolution layer and an activation layer connected to the normalization layer.

The first fusion unit 303 is configured to fuse the first network layer with a weight, the normalization layer, and the activation layer to obtain the second network layer with a weight.

The target structure includes an addition layer, a first input branch of the addition layer, and a second input branch of the addition layer. The first input branch includes the first network layer with a weight and a normalization layer that are sequentially connected. The normalization layer is connected to the addition layer. A type of the second input branch is a non-weighted operation input type. The first network layer with a weight is a convolution layer.

The second fusion unit 304 is configured to fuse the first weighted network layer, the normalization layer, and the addition layer to obtain the second weighted network layer.

The second training unit 305 is configured to determine the quantized initial model as a first model, and perform fine-tuning training on the first model to obtain a second model.

The second determining unit 306 is configured to obtain, based on the second model, the service model for service processing, the service model including a second addition layer, a quantization operator added to a first input branch of the second addition layer, and a quantization operator added to a second input branch of the second addition layer, and the second addition layer in the service model being obtained based on the quantization operator and the first addition layer in the target structure.

The third training unit 307 is configured to determine the quantized initial model as a first model, and perform fine-tuning training on the first model to obtain a second model.

The third determining unit 308 is configured to obtain, based on the second model, the service model for service processing, the service model including a second concatenation layer and a quantization operator added to an input location of each input branch of the second concatenation layer, and the quantization operator added to the input location of each input branch of the second concatenation layer in the service model being obtained by equivalently propagating the quantization operator added to the output location of each output branch of the first concatenation layer in the second model forward to an input location of each input branch of the first concatenation layer in the second model.

For specific implementations of the first training unit 301, the first determining unit 302, the first fusion unit 303, the second fusion unit 304, the second training unit 305, the second determining unit 306, the third training unit 307, and the third determining unit 308, refer to the specific descriptions of operation S103 in the embodiment corresponding to FIG. 3. Details are not described herein again.

The feature obtaining module 40 is configured to obtain an image feature of a to-be-recognized image when the to-be-recognized image is obtained if service processing of the service model is image recognition.

The feature input module 50 is configured to input the image feature into the service model, an optimized structure in the service model including a target network layer and a quantization operator added to an input location of the target network layer, and the target network layer being obtained based on the quantization operator and an original network layer of the target structure in the initial model.

The precision conversion module 60 is configured to convert, based on the quantization operator added to the input location of the target network layer, precision of an input feature of the optimized structure from first precision to second precision, the first precision being higher than the second precision.

The feature extraction module 70 is configured to perform feature extraction processing on the input feature of the second precision by using the target network layer, so that the target network layer outputs an output feature corresponding to the input feature.

The class determining module 80 is configured to obtain a predicted class of the to-be-recognized image based on the output feature.

For specific implementation of the search module 10, the quantization module 20, the service model determining module 30, the feature obtaining module 40, the feature input module 50, the precision conversion module 60, the feature extraction module 70, and the class determining module 80, refer to the descriptions of operation S201 to operation S208 in the embodiment corresponding to FIG. 14. Details are not described herein again. In addition, beneficial effects of the same method are not described herein again.

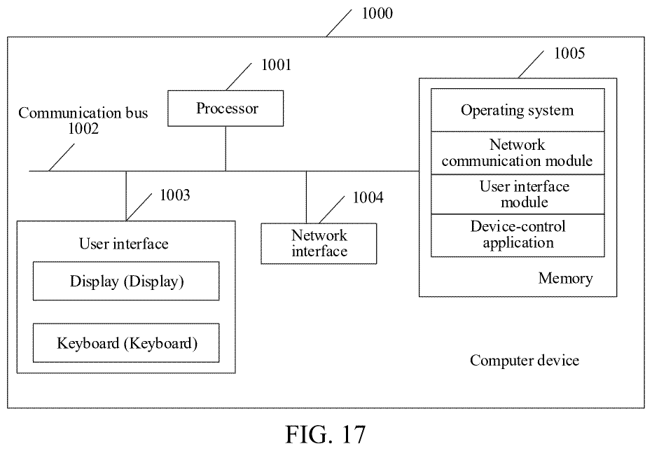

Further, FIG. 17 is a schematic diagram of a computer device according to an embodiment of the present disclosure. As shown in FIG. 17, the computer device 1000 may include at least one processor 1001, for example, a CPU, at least one network interface 1004, a memory 1005, and at least one communication bus 1002. The communications bus 1002 is configured to implement connection and communication between the components. In some embodiments, the network interface 1004 may include a standard wired interface and wireless interface (for example, a Wi-Fi interface). The memory 1005 may be a high-speed RAM, or may be a non-volatile memory, for example, at least one magnetic disk memory. In some embodiments, the memory 1005 may be at least one storage apparatus located far away from the processor 1001. As shown in FIG. 17, the memory 1005 used as a computer storage medium may include an operating system, a network communication module, a user interface module, and a device-control application. In some embodiments, the computer device may further include a user interface 1003 shown in FIG. 17. For example, if the computer device is a terminal device with a model quantification function shown in FIG. 1 (for example, the terminal device 100b), the computer device may further include the user interface 1003. The user interface 1003 may include a display, a keyboard, and the like.

In the computer device 1000 shown in FIG. 17, the network interface 1004 is mainly configured to perform network communication. The user interface 1003 is mainly configured to provide an input interface for a user. The processor 1001 may be configured to invoke the device-control application stored in the memory 1005, to implement:
performing, when obtaining an initial model, structure search on the initial model to obtain a model structure diagram of the initial model;
quantizing, based on a type of a target structure in the model structure diagram, the target structure by using a fake operator for quantization, the fake operator includes a quantization operator and a dequantization operator; and
obtaining, based on a quantized initial model, a service model for service processing.

The computer device 1000 described In one embodiment can implement the descriptions about the data processing method in the foregoing embodiments corresponding to FIG. 3 and FIG. 14, and can also implement the descriptions about the data processing apparatus 1 in the foregoing embodiment corresponding to FIG. 16. Details are not described herein again. In addition, beneficial effects of the same method are not described herein again.

An embodiment of the present disclosure further provides a computer-readable storage medium, having a computer program stored therein. The computer program includes program instructions. When the program instructions are executed by a processor, the data processing methods provided by the operations in FIG. 3 and FIG. 14 are implemented. For details, refer to the implementations provided by the operations in FIG. 3 and FIG. 14. The details are not described herein again.

The computer-readable storage medium may be an internal storage unit of the data processing apparatus or the computer device provided in any one of the foregoing embodiments, for example, a hard disk drive or an internal memory in the computer device. The computer-readable storage medium may alternatively be an external storage device of the computer device, for example, a plug-in hard disk drive, a smart media card (SMC), a secure digital (SD) card, or a flash card on the computer device. Further, the computer-readable storage medium may alternatively include both an internal storage unit and an external storage device of the computer device. The computer-readable storage medium is configured to store the computer program and other programs and data that are required by the computer device. The computer-readable storage medium may be further configured to temporarily store data that has been output or is to be output.

An embodiment of the present disclosure further provides a computer program product, including a computer program. The computer program is stored in a computer-readable storage medium. A processor of a computer device reads the computer program from the computer-readable storage medium. The processor executes the computer program, so that the computer device implements the descriptions of the data processing method or apparatus in the foregoing embodiments. Details are not described herein again. In addition, beneficial effects of the same method are not described herein again.

As such, when a computer device with a model quantization function obtains the initial model, the fake operator does not need to be manually added to the initial model. Instead, after the model structure diagram of the initial model is searched, the target structure is directly automatically quantized by using the fake operator for quantization (the fake operator herein may include the quantization operator and the dequantization operator) based on the type of the target structure in the model structure diagram of the initial model, and after quantization is ended, the service model for service processing may be determined based on the quantized initial model. In other words, in the data processing method provided in the embodiments of the present disclosure, model quantization is performed without manual participation. For any initial model, an accelerable to-be-quantized structure (that is, a target structure) existing in the initial model may be automatically quantized by using a fake operator for quantization based on a type of the target structure in a model structure diagram. This can effectively reduce labor costs, improve the model quantization speed, and achieve generality of model quantization. The terms “first”, “second”, and the like in the specification, the claims, and the drawings in the embodiments of the present disclosure are used to distinguish between different objects rather than describe a specific sequence. In addition, the term “include” and any variant thereof are intended to cover a non-exclusive inclusion. For example, a process, method, apparatus, product, or device including a series of operations or units are not limited to the listed operations or modules, but instead, further includes operations or modules not listed in some embodiments, or further include other operations or units inherent in the process, method, apparatus, product, or device in some embodiments.

A person of ordinary skill in the art may be aware that the units and the algorithm steps in the examples described with reference to the embodiments disclosed in this specification can be implemented by electronic hardware, computer software, or a combination thereof. To clearly describe interchangeability between hardware and software, the foregoing has generally described compositions and steps of the examples based on functions. Whether the functions are executed in a mode of hardware or software depends on particular applications and design constraint conditions of the technical solutions. A person skilled in the art may use different methods to implement the described functions for each particular application, but it shall not be considered that the implementation goes beyond the scope of the present disclosure.

What is disclosed above is merely exemplary embodiments of the present disclosure, and certainly is not intended to limit the scope of the claims of the present disclosure. Therefore, equivalent variations made in accordance with the claims of the present disclosure shall fall within the scope of the present disclosure.

What is claimed is:

1. A data processing method, comprising:
performing, when obtaining an initial model, structure search on the initial model to obtain a model structure diagram of the initial model;
quantizing, based on a type of a target structure in the model structure diagram of the initial model, the target structure of the initial model by applying a fake operator for quantization, the fake operator comprising a quantization operator and a dequantization operator; and
obtaining, based on the quantized initial model, a service model for service processing.

2. The data processing method according to claim 1, wherein quantizing the target structure by applying the fake operator for quantization comprises:
adding, in response to the target structure in the model structure diagram comprising a first network layer with a weight, the fake operator to an input location of the first network layer with a weight, and quantizing a weight of the first network layer by using the fake operator.

3. The data processing method according to claim 2, further comprising:
adding, in response to the first network layer with a weight having a plurality of output locations, fake operators separately to the plurality of output locations of the first network layer with a weight.

4. The data processing method according to claim 2, further comprising:
adding, in response to the first network layer with a weight having one output location and no activation layer is connected to the output location of the first network layer with a weight, the fake operator to the output location of the first network layer with a weight.

5. The data processing method according to claim 2, further comprising:
skipping adding, in response to the first network layer with a weight having one output location and an activation layer is connected to the output location of the first network layer with a weight, the fake operator to the output location of the first network layer with a weight.

6. The data processing method according to claim 2, further comprising:
adding, in response to the target structure in the model structure diagram comprising an addition layer, a first input branch of the addition layer, and a second input branch of the addition layer, the fake operator to an output location of the addition layer,
the first input branch comprising the first network layer with a weight and a normalization layer that are sequentially connected, the normalization layer being connected to the addition layer, a type of the second input branch being a non-weighted operation input type, and the first network layer with a weight being a convolution layer.

7. The data processing method according to claim 6, further comprising:
adding the fake operator to an input location of the second input branch.

8. The data processing method according to claim 1, wherein quantizing the target structure by applying the fake operator for quantization comprises:
adding, in response to the target structure in the model structure diagram comprising a first addition layer, and a type of a first input branch of the first addition layer and a type of a second input branch of the first addition layer are both a non-weighted operation input type, a fake operator to an input location of the first input branch, adding a fake operator to an input location of the second input branch, and adding a fake operator to an output location of the first addition layer.

9. The data processing method according to claim 1, wherein quantizing the target structure by applying the fake operator for quantization comprises:
adding, in response to the target structure in the model structure diagram comprising a first concatenation layer, and a quantity of input branches of the first concatenation layer is same as a quantity of output branches of the first concatenation layer, a fake operator to an output location of each of N output branches of the first concatenation layer, N being a positive integer greater than 1, and a quantization operator of the fake operator added to each output branch being same.

10. The data processing method according to claim 2, wherein obtaining the service model for service processing comprises:
determining the quantized initial model as a first model, and performing fine-tuning training on the first model to obtain a second model; and
obtaining, based on the second model, the service model for service processing,
the service model comprising a second network layer with a weight and a quantization operator added to an input location of the second network layer with a weight, the second network layer with a weight in the service model being obtained based on the second network layer with a weight, and a weight of the second network layer with a weight being obtained by processing the weight of the second network layer with a weight in the second model by using the quantization operator.

11. The data processing method according to claim 10, wherein the first network layer with a weight in the target structure is a convolution layer, and the target structure further comprises a normalization layer connected to the convolution layer and an activation layer connected to the normalization layer; and
the data processing method further comprises:
fusing the first network layer with a weight, the normalization layer, and the activation layer to obtain the second network layer with a weight.

12. The data processing method according to claim 10, wherein the target structure comprises an addition layer, a first input branch of the addition layer, and a second input branch of the addition layer, the first input branch comprises the first network layer with a weight and a normalization layer that are sequentially connected, the normalization layer is connected to the addition layer, a type of the second input branch is a non-weighted operation input type, and the first network layer with a weight is a convolution layer; and
the data processing method further comprises:
fusing the first network layer with a weight, the normalization layer, and the addition layer to obtain the second network layer with a weight.

13. The data processing method according to claim 8, wherein obtaining the service model for service processing comprises:
determining the quantized initial model as a first model, and performing fine-tuning training on the first model to obtain a second model; and
obtaining, based on the second model, the service model for service processing,
the service model comprising a second addition layer, a quantization operator added to a first input branch of the second addition layer, and a quantization operator added to a second input branch of the second addition layer, and the second addition layer in the service model being obtained based on the quantization operator and the first addition layer in the target structure.

14. The data processing method according to claim 9, wherein obtaining the service model for service processing comprises:
determining the quantized initial model as a first model, and performing fine-tuning training on the first model to obtain a second model; and
obtaining, based on the second model, the service model for service processing,
the service model comprising a second concatenation layer and a quantization operator added to an input location of each input branch of the second concatenation layer, and the quantization operator added to the input location of each input branch of the second concatenation layer in the service model being obtained by equivalently propagating the quantization operator added to the output location of each output branch of the first concatenation layer in the second model forward to an input location of each input branch of the first concatenation layer in the second model.

15. The data processing method according to claim 1, further comprising:
obtaining an image feature of a to-be-recognized image when the to-be-recognized image is obtained in response to the service processing of the service model being image recognition;
inputting the image feature into the service model, an optimized structure in the service model comprising a target network layer and a quantization operator added to an input location of the target network layer, and the target network layer being obtained based on the quantization operator and an original network layer of the target structure in the initial model;
converting, based on the quantization operator added to the input location of the target network layer, precision of an input feature of the optimized structure from first precision to second precision, the first precision being higher than the second precision;
performing feature extraction processing on the input feature of the second precision by using the target network layer, so that the target network layer outputs an output feature corresponding to the input feature; and
obtaining a predicted class of the to-be-recognized image based on the output feature.

16. A computer device, comprising:
one or more processors, a memory, and a network interface,
the one or processor being connected to the memory and the network interface, the network interface being configured to provide a data communication function, and the memory being configured to store a computer program that, when being executed, causes the one or more processors to perform:
performing, when obtaining an initial model, structure search on the initial model to obtain a model structure diagram of the initial model;
quantizing, based on a type of a target structure in the model structure diagram of the initial model, the target structure of the initial model by applying a fake operator for quantization, the fake operator comprising a quantization operator and a dequantization operator; and
obtaining, based on the quantized initial model, a service model for service processing.

17. The device according to claim 16, wherein the one or more processors are further configured to perform:
adding, in response to the target structure in the model structure diagram comprising a first network layer with a weight, the fake operator to an input location of the first network layer with a weight, and quantizing a weight of the first network layer by using the fake operator.

18. The device according to claim 17, wherein the one or more processors are further configured to perform:
adding, in response to the first network layer with a weight having a plurality of output locations, fake operators separately to the plurality of output locations of the first network layer with a weight.

19. The device according to claim 17, wherein the one or more processors are further configured to perform:
adding, in response to the first network layer with a weight having one output location and no activation layer is connected to the output location of the first network layer with a weight, the fake operator to the output location of the first network layer with a weight.

20. A non-transitory computer-readable storage medium containing a computer program that, when being executed, causes at least one computer program to perform:
performing, when obtaining an initial model, structure search on the initial model to obtain a model structure diagram of the initial model;
quantizing, based on a type of a target structure in the model structure diagram of the initial model, the target structure of the initial model by applying a fake operator for quantization, the fake operator comprising a quantization operator and a dequantization operator; and
obtaining, based on the quantized initial model, a service model for service processing.
